(19) United States
(12) Patent Application Publication
(10) Pub. No.: US 2016/0274780 A1
(43) Pub. Date: Sep. 22, 2016

(54) INFORMATION DISPLAY APPARATUS, DISTRIBUTION APPARATUS, INFORMATION DISPLAY METHOD, AND NON-TRANSITORY COMPUTER READABLE STORAGE MEDIUM

(71) Applicant: YAHOO JAPAN CORPORATION, Tokyo (JP)

(72) Inventor: Hiroyuki ANAI, Tokyo (JP)

(73) Assignee: YAHOO JAPAN CORPORATION, Tokyo (JP)

(21) Appl. No.: 14/995,582

(22) Filed: Jan. 14, 2016

(30) Foreign Application Priority Data
Mar. 20, 2015 (JP) 2015-057657

(51) Int. Cl. G06F 3/0484

(52) U.S. Cl. CPC G06F 3/04847

(57) ABSTRACT

An information display apparatus includes a display unit that displays a first content and a second content different from the first content. The information display apparatus includes a moving unit that moves the first content and the second content in accordance with a moving operation of moving one of the first content and the second content. The information display apparatus includes a fixing unit that fixes a display position of the second content when the second content is moved to a predetermined position on a screen in accordance with the moving operation.

### CROSS-REFERENCE TO RELATED APPLICATIONS

The present application claims priority to and incorporates by reference the entire contents of Japanese Patent Application No. 2015-057657 filed in Japan on Mar. 20, 2015.

### BACKGROUND OF THE INVENTION

1. Field of the Invention

The present invention relates to an information display apparatus, a distribution apparatus, an information display method, and a non-transitory computer readable storage medium.

2. Description of the Related Art

Conventionally, there is a known technology for displaying various kinds of information on arbitrary information display apparatuses including smart devices such as smartphones or tablet personal computers (PCs), desktop PCs, and the like. As an example of the technology, there is a known technology for attracting interest in a predetermined content by displaying the content on a screen and changing display modes of the content in accordance with an operation performed by a user. For example, there is a known technology for arranging a content related to advertisement in an advertisement area set in a web page, and scrolling the content and the web page in accordance with a scroll operation performed by a user.
Patent Document 1: Japanese Laid-open Patent Publication No. 2014-049095

However, in the conventional technology as described above, in some cases, an appeal effect of information related to the content is not always high. For example, in the conventional technology, when a user continues to perform a scroll operation without paying particular attention to a content, the content is moved to the outside of the screen in accordance with the scroll operation, and the appeal effect of the information related to the content may not be achieved.

### SUMMARY OF THE INVENTION

It is an object of the present invention to at least partially solve the problems in the conventional technology.

According to one aspect of an embodiment, an information display apparatus includes a display unit that displays a first content and a second content different from the first content. The information display apparatus includes a moving unit that moves the first content and the second content in accordance with a moving operation of moving one of the first content and the second content. The information display apparatus includes a fixing unit that fixes a display position of the second content when the second content is moved to a predetermined position on a screen in accordance with the moving operation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an example of a terminal device according to an embodiment;

FIG. 2 is a diagram illustrating a configuration example of a distribution system according to the embodiment;

FIG. 3 is a diagram illustrating a configuration example of an advertisement distribution server according to the embodiment;

FIG. 4 is a diagram illustrating an example of information stored in an advertisement database according to the embodiment;

FIG. 5 is a diagram illustrating a configuration example of a content distribution server according to the embodiment;

FIG. 6 is a diagram illustrating a configuration example of the terminal device according to the embodiment;

FIG. 7 is a diagram for explaining an example of setting of a tracking area;

FIG. 8 is a diagram illustrating an example of a process for displaying a plurality of contents by the terminal device according to the embodiment;

FIG. 9 is a diagram for explaining another example of setting of the tracking area;

FIG. 10 is a diagram illustrating an example of a process for displaying a plurality of contents by the terminal device according to the embodiment;

FIG. 11 is a diagram for explaining an example of setting of the tracking area when contents are displayed in an overlapping manner;

FIG. 12 is a diagram illustrating an example of a process for fixing a content at a plurality of display positions by the terminal device according to the embodiment;

FIG. 13 is a flowchart illustrating an example of the flow of a display process performed by the terminal device according to the embodiment; and

FIG. 14 is a diagram illustrating an example of a hardware configuration of a computer that implements functions of the advertisement distribution server.

### DETAILED DESCRIPTION OF THE PREFERRED EMBODIMENTS

Modes (hereinafter, referred to as “embodiments”) for carrying out an information display apparatus, a distribution apparatus, an information display method, and a non-transitory computer readable storage medium according to the present invention will be described in detail below with reference to the drawings. The information display apparatus, the distribution apparatus, the information display method, and the non-transitory computer readable storage medium of the present invention are not limited by the embodiments. In each of the embodiments below, the same components will be denoted by the same reference numerals and symbols, and description thereof will be omitted.

1. Example of Terminal Device 100

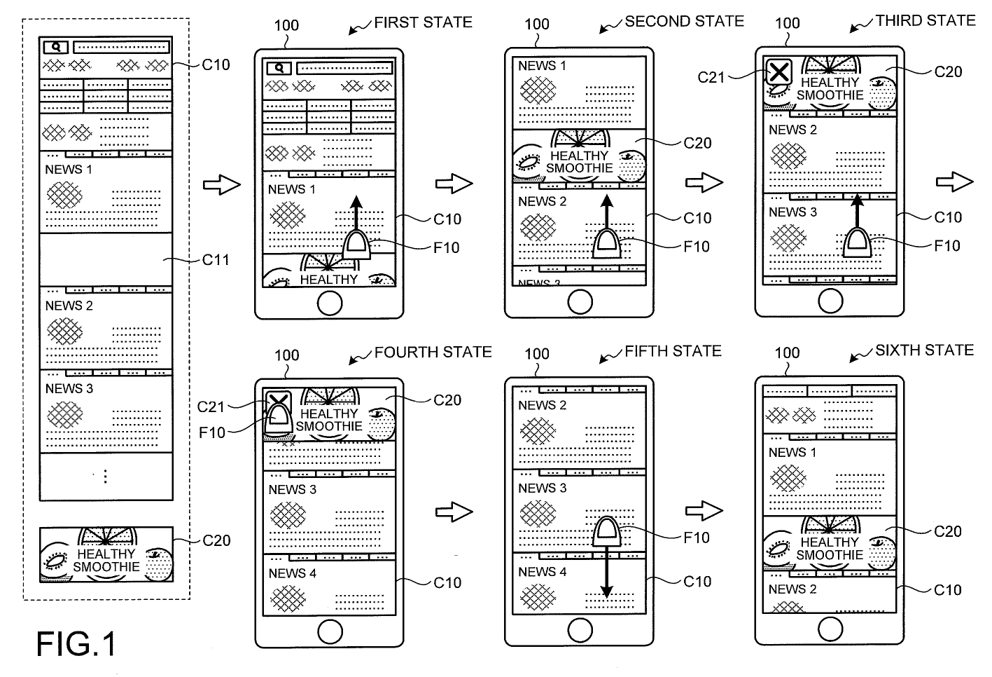

First, an example of a process performed by a terminal device 100 as an example of an information display apparatus will be described with reference to FIG. 1. FIG. 1 is a diagram illustrating an example of the terminal device according to the embodiment. FIG. 1 illustrates an example in which the terminal device 100 displays a web page C10 and a content C20.

The terminal device 100 illustrated in FIG. 1 is a smart device, such as a smartphone or a tablet, and is a mobile terminal device that can communicate with an arbitrary server device via a wireless communication network, such as third generation (3G) or a long term evolution (LTE). The terminal device 100 includes an output unit 130, such as a liquid crystal display. It is assumed that a touch panel is used in the terminal device 100. That is, a user of the terminal device 100 performs various operations by touching a display surface (hereinafter, may be described as a screen) of the output unit 130 with a finger or a stylus.

The web page C10 is a web page in which, for example, news, a weather forecast, an index or a content of received mail, a photo viewer, and various other contents are arranged, and which is described in a hyper text markup language (HTML), an extensible markup language (XML), or the like. In the web page C10, an advertisement area C11 with a predetermined size is arranged, and the content C20 distributed separately from the web page C10 is displayed.

In the following description, it is assumed that the web page C10 is a web page of a so-called portal site. It is also assumed that the web page C10 is a web page which is optimized for smart devices and whose display size in the horizontal direction is the same as a display size of the screen of the terminal device 100 in the horizontal direction. It is also assumed that the web page C10 is a web page whose display size in the vertical direction is longer than a display size of the output unit 130 of the terminal device 100 in the vertical direction and in which contents related to a plurality of news, such as “news 1” to “news 5”, are arranged.

The web page C10 may be a content in which, for example, news, a weather forecast, an index or a content of received mail, a photo viewer, and various other contents are independently arranged in tile shapes and in which an operation, an update, or the like can be performed for each of the contents arranged in the tile shapes. In this case, the size of each of the tiles arranged in the web page C10, arrangement positions, the number of arranged tiles may be automatically changed for each tile or may be changed in accordance with an operation performed by a user. The web page C10 may be a web page described in an HTML, an XML, or the like. The web page C10 as described above includes an input field for inputting a search keyword, a link to a different web page, or the like.

The content C20 is a content displayed together with the web page C10, and is, for example, a content related to advertisement (hereinafter, described as an advertisement content). For example, the content C20 is an image or a moving image with the same size as the advertisement area C11 included in the web page C10. In the example illustrated in FIG. 1, it is assumed that a photograph of fruits and characters, such as “healthy smoothie”, related to advertisement are arranged.

The content C20 may be configured with a plurality of contents each being independent of the others, or may be configured such that a plurality of contents each being independent of the others are combined so as to provide a single different content as a whole. Furthermore, the content C20 may be configured with an arbitrary number of contents.

As will be described later, the content C20 is a content whose arrangement position and display position are set by using cascading style sheets (CSS), HTML5, or other scripts that can describe dynamic contents, and therefore whose display mode is changed in accordance with an operation performed by a user. For example, the content C20 is a content including an image, a character, a graphic, a symbol, a moving image, or the like subjected to control for display, deletion, expansion, reduction, movement, rotation, playback, pause, or the like in accordance with an operation performed by a user. The content C20 may be a web page described in an HTML, an XML, or the like, similarly to the web page C10.

It is assumed that the content related to advertisement is not only commercial and non-commercial advertisements, but also recruitment of volunteers, public service advertisements, notifications to the public, a part of information related to the web page C10, or any other arbitrary content. That is, as the content C20, not only a content including so-called advertisement related information, but also an image, a moving image, a character, a graphic, a symbol, a hyper link, or any other arbitrary content may be used as long as the content attracts interest of a user and conveys information contained in the content C20 or information contained in a content (for example, a landing page or the like) related to the content C20.

The terminal device 100, upon receiving distribution of the web page C10, transmits a distribution request to an advertisement distribution server 20 that distributes a content related to advertisement. Then, upon receiving distribution of the content C20 as the content related to advertisement from the advertisement distribution server 20, the terminal device 100 arranges the content C20 in the advertisement area C11 included in the web page C10, and displays the web page C10 and the content C20.

2. Process Performed by the Terminal Device 100

In the conventional technology, the web page C10 and the content C20 are displayed in a mode in which when a scroll operation is performed on the web page C10, the content C20 is moved together with the web page C10 such that the content C20 is included as a part of the web page C10. However, in the conventional technology, if a user continues to perform the scroll operation without viewing the content C20, the content C20 is moved to the outside of the screen, and an appeal effect of information related to the content C20 is not achieved.

Conventionally, a display process has been performed to improve the number of impressions of the content C20 by arranging the content C20 within a range in which an initial display of the web page C10 is provided. However, if a user scrolls the web page C10 before distribution of the content C20, the number of impressions is counted based on the assumption that the content C20 is viewed, even though the user does not actually view the content C20.

Furthermore, there may be a technology in which when a scroll operation is performed, only the web page C10 is scrolled while the content C20 is continuously displayed in a predetermined position on the screen in order to cause a user to view the content C20. However, in this technology, the user who pays close attention to the web page C10 may get a negative impression from the content. In contrast, fees for advertisement distribution are charged with respect to user's viewing, selection, or the like, and therefore, it is preferable to provide the content related to advertisement such that the content can easily attract attention of the user.

2-1. Display Process

In view of the above, the terminal device 100 performs a display process as described below. For example, the terminal device 100 displays the web page C10 and the content C20. If a scroll operation for moving the web page C10 or the content C20 is performed, the terminal device 100 moves the web page C10 and the content C20. If the content C20 is moved to a predetermined position as a result of the scroll operation, the terminal device 100 fixes a position at which the content C20 is displayed on the screen (hereinafter, described as a display position of the content C20).

A specific example of the display process performed by the terminal device 100 will be described below. In the following description, an end that serves as a reference position when the web page C10 or the content C20 is displayed on the screen and that is arranged on the uppermost side on the screen when the web page C10 or the content C20 is displayed will be described as an upper end of the web page C10 or the content C20. Furthermore, an end that is arranged on the lowermost side on the screen among the ends that appear when the web page C10 or the content C20 is displayed on the screen will be described as a lower end of the web page C10 or the content C20.

Moreover, in the following description, an end of the screen that serves as a reference when the web page C10 or the content C20 is displayed and that is provided in a direction in which an upper side of the web page C10 or the content C20 is displayed will be described as an upper end of the screen, and an end of the screen that is provided in a direction in which a lower side of the web page C10 or the content C20 is displayed will be described as a lower end of the screen. Furthermore, a direction in which the upper end of the web page C10 or the content C20 is displayed on the screen of the terminal device 100 will be described as a screen upward direction, and a direction in which the lower end of the web page C10 or the content C20 is arranged on the screen will be described as a screen downward direction.

For example, the terminal device 100 arranges the content C20 in the advertisement area C11 of the web page C10, and displays, as an initial screen, the web page C10 and the content C20 such that the upper end of the web page C10 and the upper end of the screen come in contact with each other. If a display position of the advertisement area C11 is located outside the screen in the initial screen, the terminal device 100 may not include the content C20 in the initial screen.

If a scroll operation for moving the web page C10 or the content C20 in the screen upward direction (hereinafter, described as an upward scroll operation) is performed, the terminal device 100 scrolls the web page C10 and the content C20 in the screen upward direction. Then, if the display position of the content C20 reaches a predetermined position, the terminal device 100 fixes the display position of the content C20, and scrolls only the web page C10 in accordance with the scroll operation.

For example, if the upper end of the content C20 comes in contact with the upper end of the screen, that is, if the display position of the content C20 reaches the upper end of the screen, the terminal device 100 fixes a display position of the content C20. Then, if an upward scroll operation is performed, the terminal device 100 scrolls only the web page C10 in the screen upward direction without moving the content C20. Therefore, for example, even when the area of the web page C10 displayed on the screen is moved in accordance with the scroll operation and the advertisement area C11 is moved to the outside of the screen, the terminal device 100 can display the content C20 such that the content C20 tracks the screen.

The terminal device 100 may fix the display position of the content C20 at an arbitrary position in any case other than the case where the upper end of the content C20 comes in contact with the upper end of the screen, and may fix the display position of the content C20 when a part of the content C20 is moved to the outside of the screen. That is, the terminal device 100 may fix the content C20 when the content C20 is moved to an end of the screen in a direction in which the scroll operation is performed. For example, the terminal device 100 may fix the display position of the content C20 when an upward scroll operation is performed such that the content C20 is moved further from the upper end of the screen in the screen upward direction and a predetermined area, such as an upper half, of the content C20 is moved to the outside of the screen. Consequently, because the terminal device 100 fixes, at the end of the screen in the scroll direction, the display position of the content C20 moving in the scroll direction, it is possible to make the user aware of the content C20 and improve the appeal effect of the information related to the content C20.

2-2. Display Process after Fixation

If the terminal device 100 continues to display the content C20, a display area of the web page C10 is reduced, and this may give a negative impression of the information related to the content C20. Therefore, when the terminal device 100 fixes the display position of the content C20, the terminal device 100 performs a display process as described below.

For example, upon fixing the display position of the content C20, the terminal device 100 displays a release button C21 so as to overlap the content C20 such that the release button C21, when selected by a user, releases the fixed display position of the content C20. If the user taps the release button C21, the terminal device 100 releases the fixed display position of the content C20. If the fixed display position of the content C20 is released, the terminal device 100 arranges and displays the content C20 in the advertisement area C11.

Therefore, for example, the terminal device 100 can control the display mode of the content C20 such that when the user taps the release button C21 and if the advertisement area C11 is located outside the screen, the displayed content C20 disappears because of the tapping of the release button. The terminal device 100 may cancel display of the content C20 when the user taps the release button C21.

After the user taps the release button C21, the terminal device 100 arranges and displays the content C20 in the advertisement area C11, and scrolls the web page C10 and the content C20 in accordance with an upward scroll operation or a downward scroll operation. That is, when the user taps the release button, the terminal device 100 displays the web page C10 and the content C20 in a normal display mode.

If the user performs a predetermined operation without tapping the release button after fixation of the display position of the content C20, the terminal device 100 may release the fixed display position of the content C20. For example, if the user performs a scroll operation for moving the content C20 in the horizontal direction of the screen, the terminal device 100 may delete the display of the content C20 and arrange the content C20 in the advertisement area C11.

If the user further performs an upward scroll operation equal to or greater than a predetermined threshold after fixation of the display position of the content C20, the terminal device 100 may release the fixed display position of the content C20. If a predetermined time (for example, three seconds) has elapsed after fixation of the display position of the content C20, the terminal device 100 may release the fixed display position of the content C20. In this case, if the content C20 is moved in the screen upward direction in accordance with the scroll operation and the entire content C20 is moved to the outside of the screen, the terminal device 100 may arrange the content C20 in the advertisement area C11.

If the fixed display position of the content C20 is released, the terminal device 100 may reduce an area of the content C20 being displayed (hereinafter, described as a display area of the content C20) in the screen upward direction without moving the content C20 in accordance with a scroll operation. Specifically, the terminal device 100 may not move the content C20 but may move a lower end of the display area of the content C20 in a direction toward an upper end of the display area of the content C20 in order to gradually reduce the display area of the content C20.

When the display position of the content C20 is fixed, and if a downward scroll operation is performed and the display position of the content C20 and the display position of the advertisement area C11 coincide with each other, the terminal device 100 may release the fixed display position of the content C20. That is, the terminal device 100 may continue to display the content C20 at the upper end of the screen when the display position of the advertisement area C11 is moved to the outside of the screen by the upward scroll operation, and may move the content C20 as if the content C20 is arranged in the advertisement area C11 when the display position of the advertisement area C11 is moved to the inside of the screen by the downward scroll operation.

2-3. Method to Implement Display Process

The terminal device 100 can implement the above-described display process by an arbitrary method. For example, the terminal device 100 may monitor any of the position at which the advertisement area C11 is displayed, the display position of the content C20, and an amount of scroll, and fix the display position of the content C20 or release the fixed display position of the content C20 depending on whether the monitored information meets a predetermined condition.

For example, the terminal device 100 obtains the number of pixels from the upper end of the web page C10 to the upper end of the advertisement area C11 as a predetermined threshold, and determines whether an upward scroll operation equal to or greater than the predetermined threshold is performed after the web page C10 is displayed. If the upward scroll operation equal to or greater than the predetermined threshold is performed, the terminal device 100 may fix the display position of the content C20.

Furthermore, the terminal device 100 may implement the above-described display process by using a script, such as CSS. For example, the terminal device 100 arranges the content C20 in the advertisement area C11. The terminal device 100 sets, as a parent element of the content C20, an area in which the display position of the content C20 is fixed at the upper end or the lower end of the screen even when a scroll operation is performed, that is, a tracking area that causes the content C20 to track the movement of an area of the web page C10 displayed on the screen. The tracking area is implemented by a script, such as sticky.

Specifically, even when the advertisement area C11 is moved to the outside of the screen, if the tracking area of the content C20 is displayed in the screen, the terminal device 100 continues to display the content C20 in the screen. Furthermore, if the tracking area of the content C20 is set from the upper end of the advertisement area C11 to the middle of the web page C10, the terminal device 100 moves the content C20 to the outside of the screen along with movement of the lower end of the tracking area to the outside of the screen. Moreover, if the tracking area of the content C20 is set from the upper end of the advertisement area C11 to the lower end of the web page C10, the terminal device 100 continues to display the content C20 even when the web page C10 is scrolled to the end.

When reducing the display area of the content C20, the terminal device 100 monitors the amount of a scroll operation, and may reduce the display area of the content C20 in accordance with the monitored amount of the scroll operation. Furthermore, the terminal device 100 may set an arrangement area in which the content C20 is arranged at the upper end of the screen, set a visible area in which the content C20 is displayed, and move the visible area in accordance with a scroll operation.

If the arrangement area of the content C20 is set, the terminal device 100 attempts to arrange and display the content C20 on the arrangement area. However, if the visible area as the parent element is set, the terminal device 100 makes the content C20 visible in only the visible area. Therefore, the terminal device 100 sets a visible state in only a rage of the content C20, in which the content C20 is arranged and the content C20 is visible, that is, in which the arrangement area and the visible area overlap each other, and displays the range on the screen.

In this case, if the lower end of the visible area is moved in the screen upward direction relative to the lower end of the arrangement area by a scroll operation, a range of the content C20 from the lower end of the arrangement area to the lower end of the visible area is turned to an invisible state. Therefore, the terminal device 100 gradually reduces the display area of the content C20 from the lower end without moving the content C20, and displays the web page C10 arranged behind the content C20. The invisible state described herein is not implemented by controlling the transparency or the like of the content C20 by a program or a script, but is implemented by not displaying a range of the arrangement area that is not included in the visible area.

2-4. Example of Process Performed by the Terminal Device 100

An example of the display process performed by the terminal device 100 will be described below with reference to FIG. 1. In the following description, an example of a process for moving the web page C10 and the content C20 in the screen upward direction in accordance with an upward scroll operation and fixing the display position of the content C20 at the upper end of the screen will be described in multiple parts, from a first state to a sixth state. Furthermore, in the following description, it is assumed that the content C20 is arranged in the advertisement area C11 set between the news 1 and the news 2 contained in the web page C10. Moreover, in the following description, it is assumed that the tracking area of the content C20 is set from the upper end of the advertisement area C11 to the lower end of the web page C10.

First, the terminal device 100 accepts distribution of the web page C10 and the content C20. In this case, as illustrated in the first state, the terminal device 100 arranges and displays the web page C10 from the upper end of the screen, and arranges and displays the content C20 in the advertisement area C11 as an initial display. If the display position of the advertisement area C11 is located outside the screen when the upper end of the web page C10 coincides with the upper end of the screen, the terminal device 100 does not display the content C20 in the initial display.

If a user performs an upward scroll operation on the web page C10 with a finger F10, the terminal device 100 scrolls the web page C10 and the content C20 in the screen upward direction in accordance with the upward scroll operation. For example, as illustrated in the second state, the terminal device 100 moves the content C20 in the screen upward direction such that the content C20 overlaps the advertisement area C11.

As illustrated in the third state, if the display position of the content C20 reaches the upper end of the screen, the terminal device 100 fixes the display position of the content C20 and displays the release button C21. Therefore, as illustrated in the fourth state, even if the upward scroll is further performed and the upper end of the news 2 is moved in the upward direction relative to the lower end of the content C20, the terminal device 100 continues to display the content C20 at the upper end of the screen without moving the content C20. That is, the terminal device 100 continues to display the content C20 even when the advertisement area C11 is moved to the outside of the screen.

If the user performs a downward scroll operation on the web page C10 with the finger F10, and if the display position of the advertisement area C11 and the display position of the content C20 coincide with each other, the terminal device 100 releases the fixed display position of the content C20 and moves the content C20 in accordance with the position of the advertisement area C11. Therefore, the terminal device 100 changes the display mode from the fourth state to the third state, to the second state, and to the first state.

As illustrated in the fourth state, if the user selects the release button C21 with the finger F10, the terminal device 100 releases the fixed display position of the content C20. If this process is performed, the terminal device 100 attempts to arrange and display the content C20 in the advertisement area C11. However, because the advertisement area C11 is already moved to the outside of the screen, the terminal device 100 deletes the content C20 from the screen as illustrated in the fifth state.

If the user performs a scroll operation in the downward direction with the finger F10 after the fixed display position of the content C20 is released, the terminal device 100 moves the web page C10 and the content C20 in the downward direction in accordance with the scroll operation. Therefore, as illustrated in the sixth state, the terminal device 100 moves the web page C10 and the content C20 and displays the web page C10 and the content C20 inside the screen.

Incidentally, if a scroll operation in the upward direction is performed again in the sixth state, the terminal device 100 may not fix the display position of the content C20. Specifically, it is expected that the user who has tapped the release button C21 is not interested in the content C20. Therefore, once the release button C21 of the content C20 is tapped, the terminal device 100 moves the content C20 in accordance with the scroll operation without fixing the display position of the content C20.

In some cases, the user may be interested in the content C20 and may repeat the scroll operation. Therefore, when a downward scroll operation is performed and if the display position of the content C20 and the display position of the advertisement area C11 coincide with each other, the terminal device 100 may release the fixed display position of the content C20 and move the web page C10 and the content C20 in the screen downward direction in accordance with the downward scroll operation. Furthermore, when an upward scroll operation is performed again and the display position of the content C20 reaches the upper end of the screen, the terminal device 100 may fix the display position of the content C20 again.

Meanwhile, the terminal device 100 may display a landing page when the user selects the content C20. Furthermore, the terminal device 100 may display a different landing page depending on the display mode of the content C20. For example, if a user taps the content C20, the terminal device 100 may display a different landing page or a landing page in which different contents are arranged depending on when the display position of the content C20 is not yet fixed, when the display position of the content C20 is fixed, or when the fixed display position of the content C20 is released.

As described above, the terminal device 100 displays the web page C10 and the content C20, and if an upward scroll operation is performed on the web page C10, the terminal device 100 scrolls the web page C10 and the content C20 in the upward direction. If the display position of the content C20 reaches a predetermined display position as a result of the upward scroll operation, the terminal device 100 fixes the display position of the content C20. That is, when the upward scroll operation is performed, the terminal device 100 scrolls only the web page C10 in the upward direction without moving the content C20.

Therefore, the terminal device 100 can improve the appeal effect of the information related to the content C20. For example, even when a scroll operation is performed to move the content C20 to the outside of the screen, the terminal device 100 fixes the content C20 inside the screen and does not further move the content C20, so that it is possible to provide an opportunity to make the user aware of the content C20 and cause the user to view the content C20. As a result, it is possible to improve the appeal effect of the information related to the content C20.

Furthermore, when fixing the display position of the content C20, the terminal device 100 displays the release button in the content C20. If the user taps the release button, the terminal device 100 releases the fixed display position of the content C20 and deletes the displayed content C20. Therefore, the terminal device 100 implements an operation to allow a user who is not interested in the content C20 to delete the displayed content C20 or to return the display position of the content C20 to the advertisement area C11. Consequently, it is possible to prevent the user from getting a negative impression of the information related to the content C20.

2-5. Direction of Scroll Operation

In the above described example, the terminal device 100 fixes the display area of the content C20 at the upper end of the screen. However, the embodiment is not limited to this example. For example, the terminal device 100 may fix the display position of the content C20 at an arbitrary position, such as at the lower end of the screen or in the middle of the screen.

Furthermore, for example, if the display size of the web page C10 in the horizontal direction is greater than the size of the screen in the horizontal direction, the terminal device 100 scrolls, together with the web page C10, the content C20 whose display size in the horizontal direction is smaller than the size of the screen in the horizontal direction, along with a scroll operation in the horizontal direction. Then, the terminal device 100 may fix the content C20 at the right end or the left end of the screen.

That is, the terminal device 100 may fix the content C20 at an arbitrary position with respect to a scroll operation in an arbitrary direction as long as the terminal device 100 scrolls the content C20 together with the web page C10 and fixes the display position of the content C20 at a position at which at least a part of the content C20 is displayed on the screen. Even through the process as described above, the terminal device 100 can make the user aware of the content C20.

2-6. Execution Subject

The terminal device 100 can implement the above-described display process by using an arbitrary method, which has not been described above. For example, the terminal device 100 may implement the above-described process by downloading, in advance, an application that causes the terminal device 100 to execute the display process and by executing the application at an arbitrary timing.

Furthermore, at the same time of distribution of the web page C10 and the content C20, the terminal device 100 accepts distribution of control information for executing the above-described display process. Then, the terminal device 100 performs the above-described display process in accordance with the control information. The terminal device 100 and the like that perform the display process illustrated in FIG. 1 in accordance with the control information will be described below.

3. Configuration of Distribution System

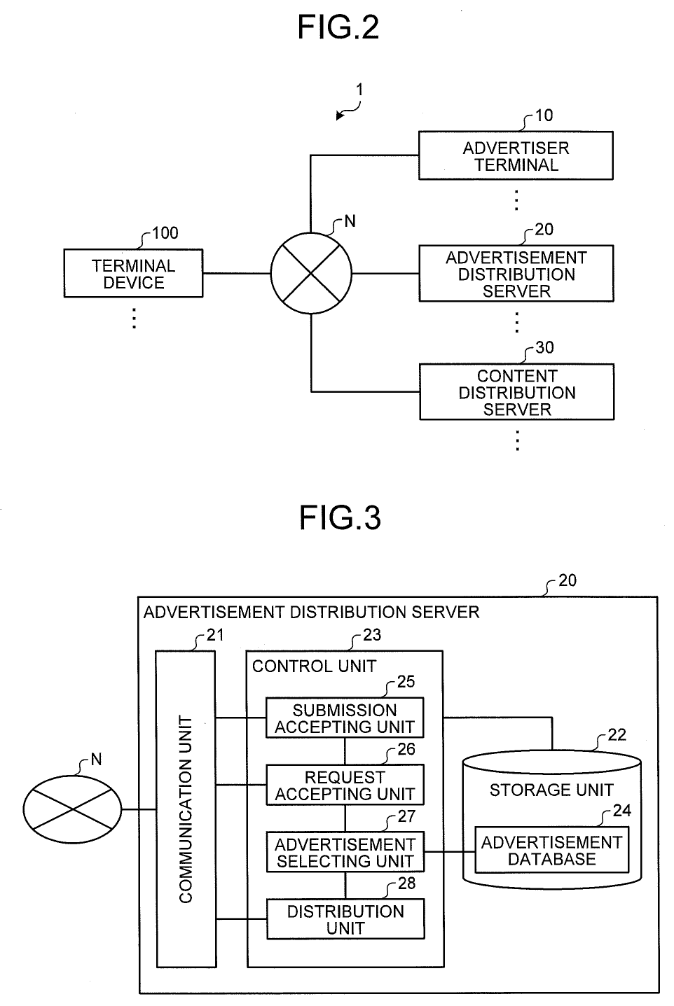

The terminal device 100 and the like that implement the above-described display process will be described below. First, a configuration of a distribution system 1 according to the embodiment will be described with reference to FIG. 2. FIG. 2 is a diagram illustrating a configuration example of the distribution system according to the embodiment. As illustrated in FIG. 2, the distribution system 1 includes the terminal device 100, an advertiser terminal 10, the advertisement distribution server 20, and a content distribution server 30. The terminal device 100, the advertiser terminal 10, the advertisement distribution server 20, and the content distribution server 30 are communicably connected to one another by wire or wireless via a network N. The distribution system 1 illustrated in FIG. 2 may include a plurality of the terminal devices 100, a plurality of the advertiser terminals 10, a plurality of the advertisement distribution servers 20, and a plurality of the content distribution servers 30.

The terminal device 100 is an information processing apparatus used by a user who views a web page. For example, the terminal device 100 is a mobile phone, such as a smartphone, a tablet terminal, a personal digital assistant (PDA), a desktop personal computer (PC), a notebook PC, or the like. The terminal device 100 acquires the web page C10 from the content distribution server 30 in accordance with an operation performed by the user, and displays the acquired web page C10. If an acquisition command to be described later is included together with the web page C10, the terminal device 100 acquires the content C20 from the advertisement distribution server 20. Furthermore, upon accepting distribution of the control information for implementing the above-described display process from the advertisement distribution server 20, the terminal device 100 operates and implements the display process in accordance with the control information.

The advertiser terminal 10 is an information processing apparatus used by an advertiser. For example, the advertiser terminal 10 is a desktop PC, a notebook PC, a tablet terminal, a mobile phone, a PDA, or the like. The advertiser terminal 10 submits an advertisement content, such as the content C20, to the advertisement distribution server 20 in accordance with an operation performed by the advertiser. For example, the advertiser terminal 10 submits, as the advertisement content, the content C20 to the advertisement distribution server 20. Furthermore, the advertiser terminal 10 submits, as the content C20, a uniform resource locator (URL) for acquiring a still image, a moving image, text data, a landing page, or the like to the advertisement distribution server 20.

In some cases, the advertiser may request an agent to submit the advertisement content. In this case, the agent submits the advertisement content to the advertisement distribution server 20. In the following, the “advertiser” is described as a concept including not only the advertiser but also the agent, and the “advertiser terminal” is described as a concept including not only the advertiser terminal 10 but also an agent terminal used by the agent.

The advertisement distribution server 20 is a server device that distributes the advertisement content submitted from the advertiser terminal 10. For example, upon accepting a distribution request for an advertisement content from the terminal device 100, the advertisement distribution server 20 performs matching between the user and an advertisement content based on a location of the terminal device 100, an attribute of the user, or the like, and distributes an advertisement content specified as a distribution target as a result of the matching.

Furthermore, the advertisement distribution server 20 distributes, to the terminal device 100, the control information for implementing the above-described display process, together with the content C20 as the advertisement content. The control information is described in a script language, such as JavaScript (registered trademark) or CSS. Meanwhile, the amount of offset of the display area may be distributed as the control information, or may be distributed as information separated from the control information.

The content distribution server 30 is a web server or the like that distributes the web page C10 to the terminal device 100. For example, the content distribution server 30 distributes, to the terminal device 100, the web page C10 in which various kinds of information related to a portal site, a news site, an auction site, a weather forecast site, a shopping site, a finance (stock price) site, a route search site, a map site, a travel site, a restaurant introduction site, a weblog, and the like are arranged in tile shapes. The content distribution server 30 may be a server that distributes a web page, such as a portal site, in which various kinds of information are arranged.

The web page C10 distributed by the content distribution server 30 includes an acquisition command. For example, the URL or the like of the advertisement distribution server 20 is described, as the acquisition command, in an HTML file or the like that forms the web page C10. In this case, the terminal device 100 accesses the URL described in the HTML file or the like, and acquires the content C20 as the advertisement content from the advertisement distribution server 20.

Various kinds of data distributed from the content distribution server 30 to the terminal device 100 are, in practice, HTML files or images that form a web page, moving images displayed with the web page, or the like.

4. Configuration of Advertisement Distribution Server

A configuration of the advertisement distribution server 20 according to the embodiment will be described below with reference to FIG. 3. FIG. 3 is a diagram illustrating a configuration example of the advertisement distribution server according to the embodiment. As illustrated in FIG. 3, the advertisement distribution server 20 includes a communication unit 21, a storage unit 22, and a control unit 23.

The communication unit 21 is implemented by, for example, a network interface card (NIC) or the like. The communication unit 21 is connected to the network N by wire or wireless, and performs transmission and reception of information with the terminal device 100, the advertiser terminal 10, and the content distribution server 30.

The storage unit 22 is implemented by, for example, a semiconductor memory device, such as a random access memory (RAM) or a flash memory, or a storage device, such as a hard disk or an optical disk. The storage unit 22 stores therein an advertisement database 24 as a database for storing various kinds of information related to an advertisement content submitted from the advertiser terminal 10.

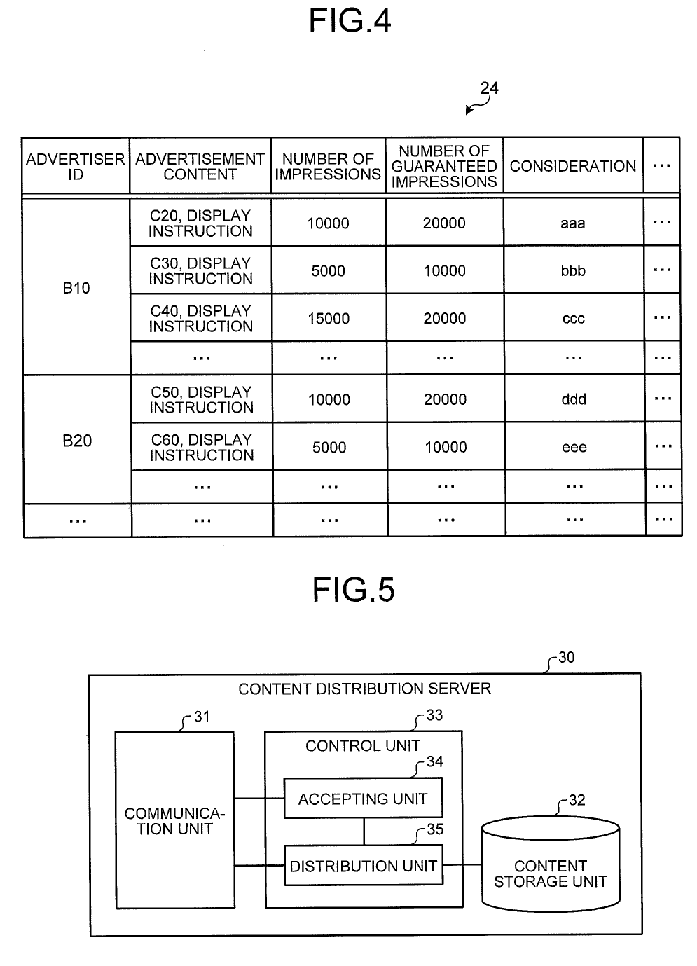

FIG. 4 is a diagram illustrating an example of information stored in the advertisement database according to the embodiment. In the example illustrated in FIG. 4, the advertisement database 24 contains items of an advertiser ID, an advertisement content, the number of impressions, the number of guaranteed impressions, and a consideration. The advertisement database 24 may further store therein information for performing matching between a content and a user, or information such as a click through rate (CTR).

The “advertiser ID” is identification information for identifying an advertiser or the advertiser terminal 10. The “advertisement content” is a content submitted from the advertiser terminal 10, that is, a content, such as the content C20, related to advertisement. In FIG. 4, an example is illustrated in which conceptual information, such as “C20” to “C60”, is stored in the “advertisement content”. However, in practice, a URL as a location of each of contents, such as an individual image, a moving image, audio and video, text data, game data, and an advertisement in a game format for conveying common information to a user, a file path name indicating a storage location of each of the contents, or the like is stored.

In the advertisement database 24, a display instruction to instruct a change in the display mode of the content C20 is registered as the advertisement content, in addition to the content C20. The display instruction includes a setting value of the tracking area of the content C20 or the like. For example, in the advertisement database 24, the number of pixels, such as “300 to 1000 pixels”, indicating a range of the tracking area with reference to the upper end of the web page C10 is registered. As will be described later, when a display process is performed to display a plurality of contents in the single web page C10 and fix a display position of each of the contents, a setting value of a tracking area for each of the contents is stored in the advertisement database 24.

Furthermore, information indicating a condition for releasing the fixed display position of the content C20 is registered in the display instruction. For example, not only an image of the release button C21 and a display timing of the release button C21, but also an amount of scroll needed to release the fixed display position, an operation content to release the fixed display position, and the like are registered in the display instruction.

Moreover, the display instruction includes information indicating an operation performed by a user, a status of the terminal device 100, or the like to be a trigger for transition to a landing page of the content C20. When an advertiser registers an advertisement content, the advertiser performs arbitrary setting for the above-described display instruction.

The “number of impressions” indicates the number of times the advertisement content is displayed. The “number of guaranteed impressions” indicates the number of displays of an advertisement content guaranteed with respect to a consideration. The “consideration” indicates a compensation to be paid by the advertiser when the advertisement content is displayed by the “number of guaranteed impressions”. That is, the advertisement distribution server 20 is a server that distributes a content related to advertisement in an impression-guaranteed form.

Specifically, FIG. 4 illustrates an example in which an advertiser identified by an advertiser ID “B10” submits the content C20 as the advertisement content. Furthermore, FIG. 4 illustrates an example in which the number of impressions of the advertisement content “C20” is “10000”, the number of guaranteed impressions is “20000”, and an amount of fees for displays of the content “C20” by the number of guaranteed impressions is “aaa”. The advertisement distribution server 20 may count the number of impressions for each of the contents C21 to C23.

When the content related to advertisement is distributed in a pay-per-click form in which a fee is charged every time the advertisement content is selected, the number of selections of the content, an amount of fees to be charged upon selection of the content, and the like are registered in the advertisement database 24. Furthermore, when an advertisement content is selected in a bidding form and the selected advertisement content is distributed upon reception of a distribution request, a bid price as an advertisement fee that is set by the advertiser as a compensation per impression, a CTR, or the like is registered in the advertisement database 24.

Referring back to FIG. 3, the description is continued. The control unit 23 is implemented by, for example, executing various programs stored in an internal storage device of the advertisement distribution server 20 by a central processing unit (CPU), a micro processing unit (MPU), or the like using a RAM as a work area. Furthermore, the control unit 23 is implemented by, for example, an integrated circuit, such as an application specific integrated circuit (ASIC) or a field programmable gate array (FPGA).

As illustrated in FIG. 3, the control unit 23 includes a submission accepting unit 25, a request accepting unit 26, an advertisement selecting unit 27, and a distribution unit 28, and implements or executes functions and operations of information processing as described below. The internal configuration of the control unit 23 is not limited to the configuration illustrated in FIG. 3, and any other configuration that performs the information processing as described below is applicable. Furthermore, a connection relation between processing units of the control unit 23 is not limited to the connection relation illustrated in FIG. 3, and any other connection relation is applicable.

The submission accepting unit 25 accepts submission of an advertisement content from the advertiser terminal 10. Specifically, the submission accepting unit 25 accepts submission of an advertisement content together with designation of a consideration. Furthermore, the submission accepting unit 25 accepts the content C20 and the display instruction. In this case, the submission accepting unit 25 registers the content C20 and the display instruction in the advertisement database 24 together with the advertiser ID and a value of the accepted consideration.

The request accepting unit 26 accepts an acquisition request for an advertisement content from the terminal device 100. For example, the request accepting unit 26 accepts an HTTP request as the acquisition request for the advertisement content.

When the request accepting unit 26 accepts the acquisition request for the advertisement content, the advertisement selecting unit 27 selects an advertisement content as a distribution candidate from the advertisement database 24. For example, the advertisement selecting unit 27 performs matching of an advertisement content to be a distribution target among advertisement contents registered in the advertisement database 24, on the basis of a location of the terminal device 100 or an attribute of the user. In the matching, the advertisement content is selected such that the number of impressions is greater than the number of guaranteed impressions. For example, the advertisement selecting unit 27 preferentially selects an advertisement content for which a difference between the number of guaranteed impressions and the number of impressions is the greatest. The advertisement selecting unit 27 may preferentially select an advertisement content with a high bid price or a high CTR, or an advertisement content with a high bid price and a high CTR. The advertisement selecting unit 27 outputs the advertisement content selected as the distribution target to the distribution unit 28.

If a web page is a search page, the advertisement selecting unit 27 may use an advertisement distribution method called search advertising to extract an advertisement content that matches a search keyword specified in a search page. Furthermore, the advertisement selecting unit 27 may use an advertisement distribution method called targeted distribution to extract an advertisement content that matches attribute information (a psychographic attribute, a demographic attribute, or the like) of the user.

The distribution unit 28 distributes the control information to the terminal device 100 together with the advertisement content selected by the advertisement selecting unit 27. Specifically, upon receiving the advertisement content selected by the advertisement selecting unit 27, the distribution unit 28 extracts a display instruction contained in the received advertisement content. The distribution unit 28 generates control information for causing the terminal device 100 to perform a display process indicated by the extracted display instruction. The control information includes, for example, information indicating the positions of the visible area and the arrangement area of each of the contents C21 to C23. Subsequently, the distribution unit 28 distributes the generated control information and the advertisement content to the terminal device 100.

5. Configuration of Content Distribution Server

A configuration of the content distribution server 30 according to the embodiment will be described below with reference to FIG. 5. FIG. 5 is a diagram illustrating a configuration example of the content distribution server according to the embodiment. As illustrated in FIG. 5, the content distribution server 30 includes a communication unit 31, a content storage unit 32, and a control unit 33.

The communication unit 31 is implemented by, for example, a NIC or the like. The communication unit 31 is connected to the network N by wire or wireless, and performs transmission and reception of information with the terminal device 100 and the advertisement distribution server 20.

The content storage unit 32 is implemented by, for example, a semiconductor memory device, such as a RAM or a flash memory, or a storage device, such as a hard disk or an optical disk. The content storage unit 32 stores therein a web page as an example of the content. For example, the content storage unit 32 stores therein an HTML file that forms a web page, or a still image or a moving image displayed on a web page.

The control unit 33 is implemented by, for example, executing various programs (corresponding to an example of a distribution program) stored in an internal storage device of the content distribution server 30 by a CPU, an MPU, or the like using a RAM as a work area. Furthermore, the control unit 33 is implemented by, for example, an integrated circuit, such as an ASIC or an FPGA.

As illustrated in FIG. 5, the control unit 33 includes an accepting unit 34 and a distribution unit 35, and implements or executes functions and operations of information processing as described below. The internal configuration of the control unit 33 is not limited to the configuration illustrated in FIG. 5, and any other configuration that performs the information processing as described below is applicable. Furthermore, a connection relation between processing units of the control unit 33 is not limited to the connection relation illustrated in FIG. 5, and any other connection relation is applicable.

The accepting unit 34 accepts an acquisition request for a web page from the terminal device 100. For example, the accepting unit 34 accepts an HTTP request as the acquisition request for a web page.

When the accepting unit 34 accepts the acquisition request for a web page, the distribution unit 35 distributes the web page to the terminal device 100. Specifically, the distribution unit 35 acquires a web page as a target of the acquisition request from the content storage unit 32, and distributes the acquired web page to the terminal device 100.

Furthermore, the distribution unit 35 generates the web page C10 and distributes the generated web page C10 to the terminal device 100. In this case, upon receiving the web page C10, the terminal device 100 transmits a distribution request for an advertisement to the advertisement distribution server 20 and displays an advertisement content received as a response. Then, the terminal device 100 performs a display process for changing the advertisement content in accordance with an operation performed by the user.

6. Configuration of Terminal Device

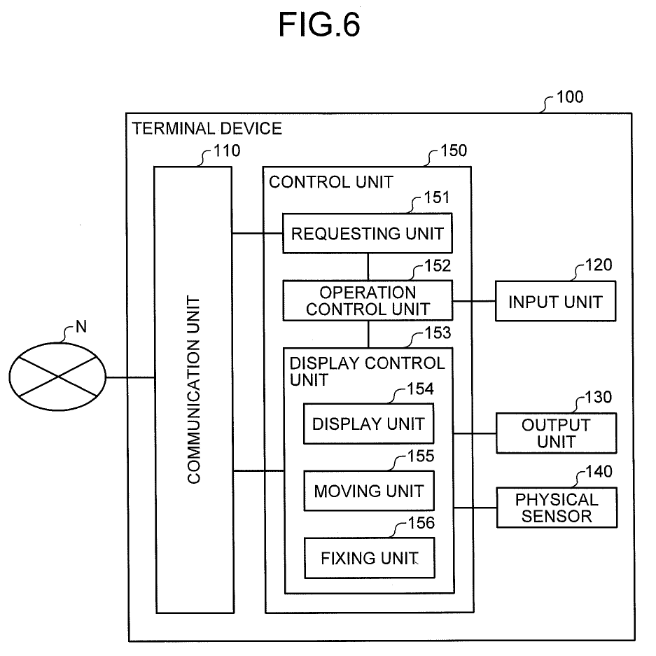

A configuration of the terminal device 100 according to the embodiment will be described below with reference to FIG. 6. FIG. 6 is a diagram illustrating a configuration example of the terminal device according to the embodiment. As illustrated in FIG. 6, the terminal device 100 includes a communication unit 110, an input unit 120, the output unit 130, a physical sensor 140, and a control unit 150.

The communication unit 110 is implemented by, for example, a NIC or the like. The communication unit 110 is connected to the network N by wire or wireless, and performs transmission and reception of information with the advertisement distribution server 20 and the content distribution server 30.

The input unit 120 is an input device that accepts various operations from a user. For example, the input unit 120 is implemented by a keyboard, a mouse, an operation key, or the like. The output unit 130 is a display device that displays various kinds of information. For example, the output unit 130 is implemented by a liquid crystal display or the like. If a touch panel is used in the terminal device 100, the input unit 120 and the output unit 130 are integrated with each other. In the following description, the output unit 130 may be described as a screen.

The physical sensor 140 is a sensor that detects a physical state of the terminal device 100. For example, the physical sensor 140 is a gyro sensor that measures inclinations of the terminal device 100 in three axial directions. The physical sensor 140 is not limited to the gyro sensor, but an arbitrary sensor, such as an acceleration sensor, a temperature sensor, a volume sensor, or a brightness sensor, is applicable.

The control unit 150 is implemented by, for example, executing various programs (corresponding to an example of a display program) stored in an internal storage device of the terminal device 100 by a CPU, an MPU, or the like using a RAM as a work area. For example, the various programs correspond to an application program called a web browser. Furthermore, the control unit 150 is implemented by, for example, an integrated circuit, such as an ASIC or an FPGA.

As illustrated in FIG. 6, the control unit 150 includes a requesting unit 151, an operation control unit 152, and a display control unit 153, and implements or executes functions and operations of information processing as described below. The internal configuration of the control unit 150 is not limited to the configuration illustrated in FIG. 6, and any other configuration that performs the information processing as described below is applicable. Furthermore, a connection relation between processing units of the control unit 150 is not limited to the connection relation illustrated in FIG. 6, and any other connection relation is applicable.

The requesting unit 151, upon receiving the URL of the web page C10 from the operation control unit 152, transmits an acquisition request for the web page C10 indicated by the received URL to the content distribution server 30. Furthermore, if the web page C10 received from the content distribution server 30 includes an acquisition command, the requesting unit 151 transmits an acquisition request for the advertisement content to the advertisement distribution server 20.

The operation control unit 152 performs various kinds of control in accordance with a user's operation accepted via the input unit 120. For example, if the user performs an operation of displaying the web page C10 through the input unit 120, the operation control unit 152 outputs the URL of the web page C10 as a display target to the requesting unit 151. Furthermore, the operation control unit 152 outputs the content of the user's operation, such as a scroll operation or a tap operation, accepted through the input unit 120 to the display control unit 153.

The display control unit 153 displays the received web page and the advertisement content on the output unit 130, and performs the above-described display process. For example, when the control unit 150 executes the control information distributed together with the advertisement content, the display control unit 153 operates as a display unit 154, a moving unit 155, and a fixing unit 156 as illustrated in FIG. 6 and performs the display process. The display unit 154, the moving unit 155, and the fixing unit 156 are implemented by, for example, executing the control information by the CPU, the MPU, or the like using the RAM as a work area.

The display unit 154 displays the web page C10 and the content C20. For example, upon receiving the web page C10 and the content C20, the display unit 154 arranges and displays the content C20 in the advertisement area C11 included in the web page C10. Furthermore, the display unit 154 scrolls the web page C10 and the content C20 in accordance with an instruction by the moving unit 155 to be described later.

Moreover, upon accepting an instruction to fix the display position of the content C20 from the fixing unit 156 to be described later, the display unit 154 fixes the display position of the content C20 and displays the release button C21 such that the release button C21 overlaps the content C20. The display unit 154 moves only the web page C10 in accordance with the instruction by the moving unit 155 without moving the content C20 until the fixed display position of the content C20 is released.

Furthermore, upon accepting an instruction to release the fixed display position of the content C20 from the fixing unit 156 to be described later, the display unit 154 arranges and displays the content C20 in the advertisement area C11. In this case, if the advertisement area C11 is located outside the screen, the display unit 154 deletes the content C20 from the screen.

The moving unit 155 scrolls the web page C10 and the content C20 in accordance with a scroll operation. For example, upon acquiring the content of a scroll operation from the operation control unit 152, the moving unit 155 specifies a direction and an amount of movement of the web page C10 and the content C20 from the acquired content of the scroll operation. Then, the moving unit 155 instructs the display unit 154 to move the web page C10 and the content C20 in the specified direction by the specified amount of movement.

As described above, the display unit 154 fixes the display position of the content C20 in accordance with the instruction from the fixing unit 156. Therefore, when the display position of the content C20 is fixed, and if the moving unit 155 instructs the display unit 154 to move the web page C10 and the content C20, only the web page C10 is moved.

Furthermore, as described above, the display unit 154 releases the fixed display position of the content C20 in accordance with the instruction from the fixing unit 156. Therefore, if the fixed display position of the content C20 is released, the moving unit 155 instructs the display unit 154 to move the web page C10 and the content C20, and the web page C10 and the content C20 are moved.

The fixing unit 156 fixes the display position of the content C20 at a predetermined position on the screen. For example, when the display position of the content C20 reaches the upper end of the screen, the fixing unit 156 outputs an instruction to fix the display position of the content C20 to the display unit 154, to thereby fix the display position of the content C20. Furthermore, when a user selects the release button C21, the fixing unit 156 outputs a notice indicating release of the fixed display position of the content C20 to the display unit 154, to thereby release the fixed display position of the content C20.

If a predetermined operation is performed after fixation of the display area of the content C20, the fixing unit 156 may release the fixed display position of the content C20. For example, if an upward scroll operation equal to or greater than a predetermined threshold is performed after fixation of the display position of the content C20, the fixing unit 156 may release the fixed display area of the content C20.

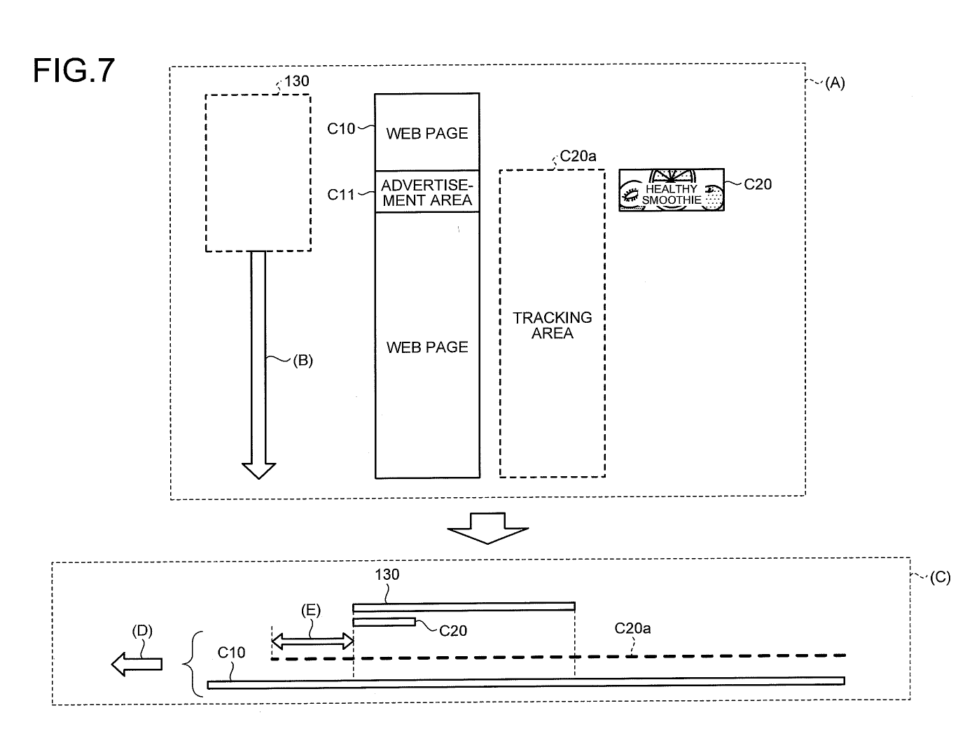

The display unit 154, the moving unit 155, and the fixing unit 156 are implemented by setting, through the above-described display process, the tracking area as a parent element of the content C20. An example of setting of the tracking area will be described below with reference to FIG. 7.

7. Example of Setting of Tracking Area

FIG. 7 is a diagram for explaining an example of setting of the tracking area. For example, in the example illustrated in (A) in FIG. 7, the advertisement area C11 is arranged in the middle of the web page C10, and a tracking area C20a of the content C20 is set from the upper end of the advertisement area C11 to the lower end of the web page. In this case, if the screen of the output unit 130 moves an area displayed on the screen in accordance with a scroll operation as indicted by (B) in FIG. 7, the terminal device 100 moves the content C20 in the tracking area C20a such that the content C20 tracks the upper end of the area being displayed, to thereby fix the display position of the content C20.

For example, as illustrated in (C) in FIG. 7, the terminal device 100 arranges the web page C10, the content C20, and the tracking area C20a. In the example illustrated in (C) in FIG. 7, a dotted line schematically representing the tracking area C20a is arranged between the web page C10 and the content C20; however, the embodiment is not limited to this example. As indicated by (D) in FIG. 7, the terminal device 100 moves the web page C10, the tracking area C20a, and the content C20 in the screen upward direction in accordance with an upward scroll operation.

If the web page C10, the tracking area C20a, and the content C20 are continuously moved by the upward scroll operation, the upper end of the content C20 comes in contact with the upper end of the screen. In this case, the terminal device 100 fixes the display position of the content C20, and scrolls only the web page C10 and the tracking area C20a in accordance with the scroll operation. That is, as indicated by (E) in FIG. 7, even when the advertisement area C11 is moved to the outside of the screen, the terminal device 100 moves the arrangement position of the content C20 such that the content C20 tracks the screen of the output unit 130 in the tracking area C20a.

Consequently, the terminal device 100 causes the user to certainly view the content C20, so that it is possible to ensure a first view of the content C20 and improve the appeal effect of the information related to the content C20.

8. Variations of Display Process

An example of the display process performed by the terminal device 100 has been described above by using the display mode illustrated in FIG. 1. However, the embodiment is not limited to the above-described example. Variations of the display process performed by the terminal device 100 will be described below. The display process described below is implemented by, for example, a process performed by the display unit 154, the moving unit 155, and the fixing unit 156; however, the embodiment is not limited to this example.

8-1. Display of a Plurality of Contents

The above-described terminal device 100 arranges and displays the single content C20 in the advertisement area C11. However, the embodiment is not limited to this example. For example, the terminal device 100 may arrange and display a plurality of contents on the web page C10.

8-1-1. Display Process for Displaying a Plurality of Contents

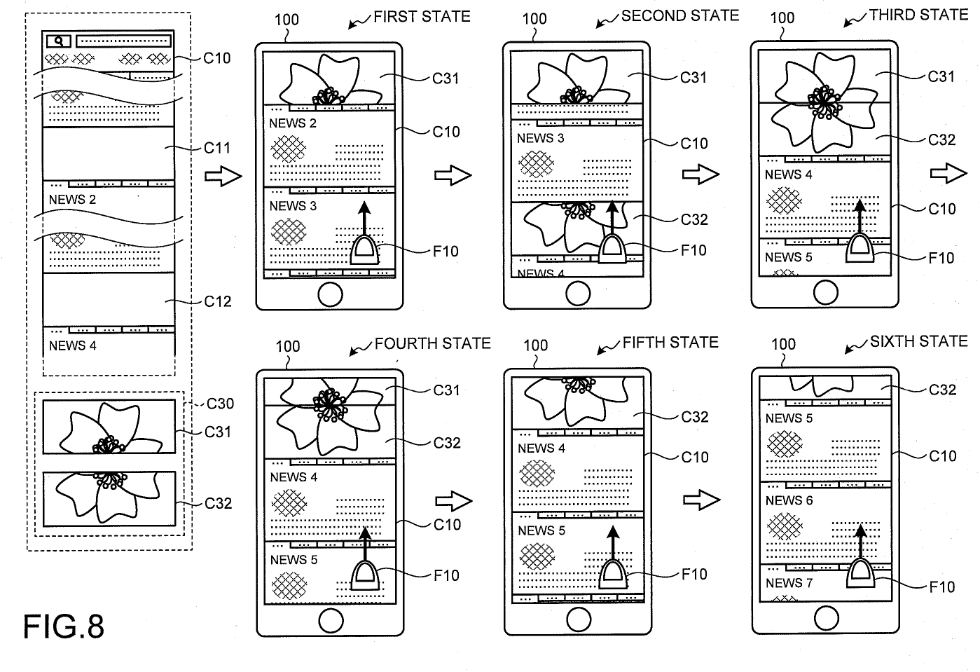

For example, FIG. 8 is a diagram illustrating an example of a process for displaying a plurality of contents by the terminal device according to the embodiment. In the example illustrated in FIG. 8, the terminal device 100 accepts distribution of the web page C10, in which the advertisement area C11 is arranged between the news 1 and the news 2 and an advertisement area C12 is arranged between the news 3 and the news 4. Furthermore, the terminal device 100 accepts, as a content C30, distribution of a plurality of contents C31 and C32 with the same sizes as the advertisement areas C11 and C12. The contents C31 and C32 are two images obtained by dividing an image with the same size as the total display size of the advertisement areas C11 and C12.

Upon accepting distribution of the web page C10 and the content C30 as described above, the terminal device 100 performs a display process as described below. First, the terminal device 100 arranges and displays the content C31 in the advertisement area C11 of the web page C10, and arranges and displays the content C32 in the advertisement area C12. Therefore, the terminal device 100 provides an initial display such that the divided images are separately located in the web page C10.

If an upward scroll operation is performed, the terminal device 100 scrolls the web page C10 and the content C30 in the screen upward direction. Then, if the upper end of the content C31 comes in contact with the upper end of the screen, the terminal device 100 fixes the display position of the content C31. Therefore, if an upward scroll operation is performed, the terminal device 100 moves the web page C10 and the content C32 in the screen upward direction.

Subsequently, if an upward scroll operation is performed and the upper end of the content C32 comes in contact with the lower end of the content C31, the terminal device 100 releases the fixed display position of the content C31. Therefore, the terminal device 100 can display the content C30 in a complicated mode such that the content C31 performs tracking in accordance with the upward scroll operation, the content C31 and the content C32 are displayed as a non-divided single image, and thereafter, the content C31 is pushed to the outside of the screen by the content C32.

Furthermore, if the upper end of the content C32 comes in contact with the upper end of the screen, the terminal device 100 fixes the display position of the content C32, and scrolls the web page C10 and the content C31 in accordance with a scroll operation. Therefore, the terminal device 100 can improve an appeal effect of information related to the content C30.

8-1-2. Example of Display Process for Displaying a Plurality of Contents

An example of a display process for displaying a plurality of the contents C31 and C32 by the terminal device 100 will be described below with reference to FIG. 8. In the following description, an example of a process for moving the web page C10 and the content C30 in the screen upward direction in accordance with an upward scroll operation and fixing the display position of the content C30 at the upper end of the screen will be described in multiple parts, from a first state to a sixth state.

First, the terminal device 100 accepts distribution of the web page C10 and the content C30. In this case, the terminal device 100 arranges the content C31 in the advertisement area C11, and arranges the content C32 in the advertisement area C12. Then, the terminal device 100 displays the web page C10 and the contents C31 and C32.

If an upward scroll operation is performed, the terminal device 100 scrolls the web page C10 and the contents C31 and C32 in the screen upward direction. If the upper end of the content C31 comes in contact with the upper end of the screen through the upward scroll operation, the terminal device 100 fixes the display position of the content C31 as illustrated in the first state.

If the upward scroll operation is further performed, as illustrated in the second state, the terminal device 100 scrolls the web page C10 and the content C32 while fixing the display position of the content C31. In the example illustrated in the second state, as a result of scrolling the web page C10 in the screen upward direction by the scroll operation, the news 2 that has been arranged below the content C31 is located behind the content C31 and the news 3 is displayed below the content C31 in the screen.

If the upward scroll operation is further performed, the terminal device 100 further scrolls the web page C10 and the content C32 in the screen upward direction while fixing the display position of the content C31. Then, as illustrated in the third state, if the lower end of the content C31 comes in contact with the upper end of the content C32, the terminal device 100 releases the fixed display position of the content C31.

Consequently, as illustrated in the fourth state, the terminal device 100 scrolls the web page C10, the content C31, and the content C32 in the screen upward direction in accordance with the upward scroll operation. Specifically, the terminal device 100 moves the contents C31 and C32 such that the content C31 and the content C32 form a single image and then the content C31 is pushed to the outside of the screen by the content C32.

Furthermore, if the upper end of the content C32 comes in contact with the upper end of the screen as a result of the upward scroll operation, the terminal device 100 fixes the display position of the content C32 as illustrated in the fifth state. If a predetermined amount of the upward scroll operation is performed, the terminal device 100 releases the fixed display position of the content C32 and scrolls the content C32 in the screen upward direction as illustrated in the sixth state. More specifically, for example, when the lower end of the content C32 comes in contact with the upper end of the news 5, the terminal device 100 releases the fixed display position of the content C32 and scrolls the content C32 such that the content C32 is pushed to the outside of the screen by the upper end of the news 5.

8-1-3. Example of Tracking Area when a Plurality of Contents are Displayed

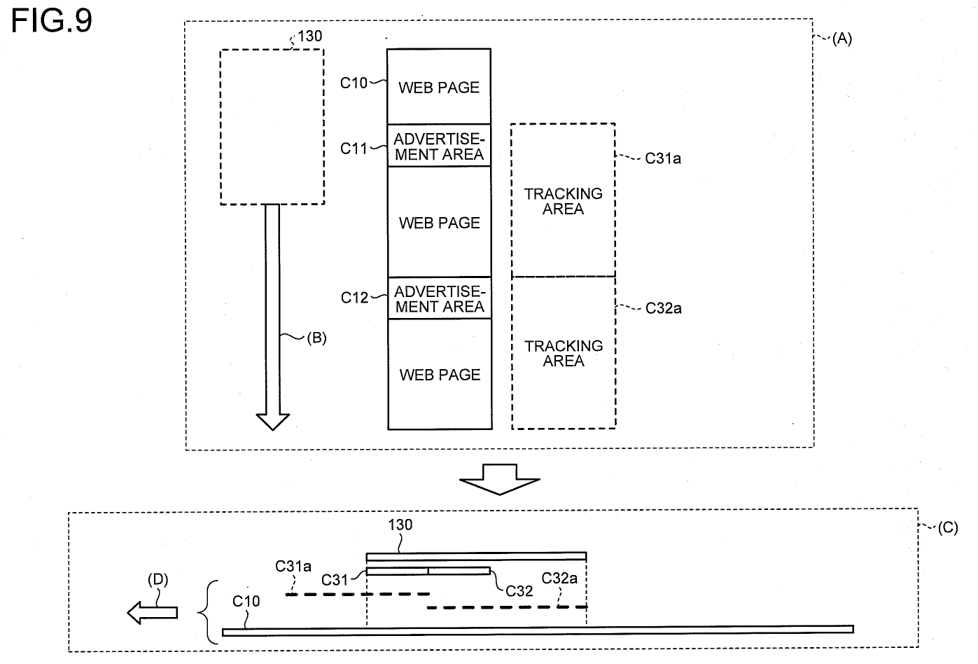

An example of setting of a tracking area for implementing the display process illustrated in FIG. 8 will be described below with reference to FIG. 9. FIG. 9 is a diagram for explaining another example of setting of the tracking area. For example, in the example illustrated in (A) in FIG. 9, the advertisement areas C11 and C12 are arranged in the middle of the web page C10. In the example illustrated in (A) in FIG. 9, a tracking area C31a of the content C31 is set between the upper end of the advertisement area C11 and the upper end of the advertisement area C12, and a tracking area C32a of the content C32 is set from the upper end of the advertisement area C12 to a predetermined position. That is, in the example illustrated in FIG. 9, the lower end of the tracking area C31a and the upper end of the tracking area C32a are brought in contact with each other by the setting.

In this case, as indicated by (B) in FIG. 9, the terminal device 100 moves an area that is displayed on the screen by the output unit 130, in accordance with a scroll operation. Then, the terminal device 100 causes the content C31 to track the area displayed on the screen until the tracking area C31a is moved to the outside of the screen, and causes the content C32 to track the area displayed on the screen from when the tracking area C32a is moved to the inside of the screen to when the tracking area C32a is moved to the outside of the screen.

For example, as illustrated in (C) in FIG. 9, the terminal device 100 arranges the web page C10, the contents C31 and C32, and the tracking areas C31a and C32a. In the example illustrated in (C) in FIG. 9, dotted lines schematically representing the tracking areas C31a and C32a are arranged between the web page C10 and the contents C31 and C32; however, the embodiment is not limited to this example. As indicated by (D) in FIG. 9, the terminal device 100 moves the content C10, the contents C31 and C32, and the tracking areas C31a and C32a in the screen upward direction in accordance with an upward scroll operation.

If the content C31 is moved in the screen upward direction by the upward scroll operation, the upper end of the content C31 comes in contact with the upper end of the screen. In this case, the terminal device 100 fixes the display position of the content C31 and scrolls the web page C10, the content C32, and the tracking areas C31a and C32a in accordance with the scroll operation. That is, even when the advertisement area C11 is moved to the outside of the screen, the terminal device 100 moves the arrangement position of the content C31 such that the content C31 tracks the output unit 130 in the tracking area C31a.

Furthermore, if the lower end of the tracking area C31a is moved in the screen upward direction relative to the lower end of the content C31 by the scroll operation, the terminal device 100 releases the fixed display position of the content C31 and moves the content C31 in accordance with the scroll operation. At this time, the lower end of the content C31a is in contact with the upper end of the tracking area C32a. Therefore, the terminal device 100 scrolls the content C31 in the screen upward direction as if the content C31 is pushed out by the content C32.

Moreover, if the upper end of the content C32 comes in contact with the upper end of the screen through the upward scroll operation, the terminal device 100 fixes the display position of the content C32 and scrolls the web page C10, the content C31, and the tracking areas C31a and C32a in accordance with the scroll operation. That is, even when the advertisement area C12 is moved to the outside of the screen, the terminal device 100 moves the arrangement position of the content C32 such that the content C32 tracks the output unit 130 in the tracking area C32a. Then, if the lower end of the tracking area C32a is moved in the screen upward direction relative to the lower end of the content C32 by the scroll operation, the terminal device 100 releases the fixed display position of the content C32 and moves the content C31 in accordance with the scroll operation.

8-2. Display of Contents in Overlapping Manner

The above-described terminal device 100 scrolls the contents C31 and C32 such that the content C32 pushes out the content C31. However, the embodiment is not limited to this example. For example, the terminal device 100 may display a plurality of contents in an overlapping manner and thereafter scroll the contents to the outside of the screen.

8-2-1. Display Process for Displaying a Plurality of Contents

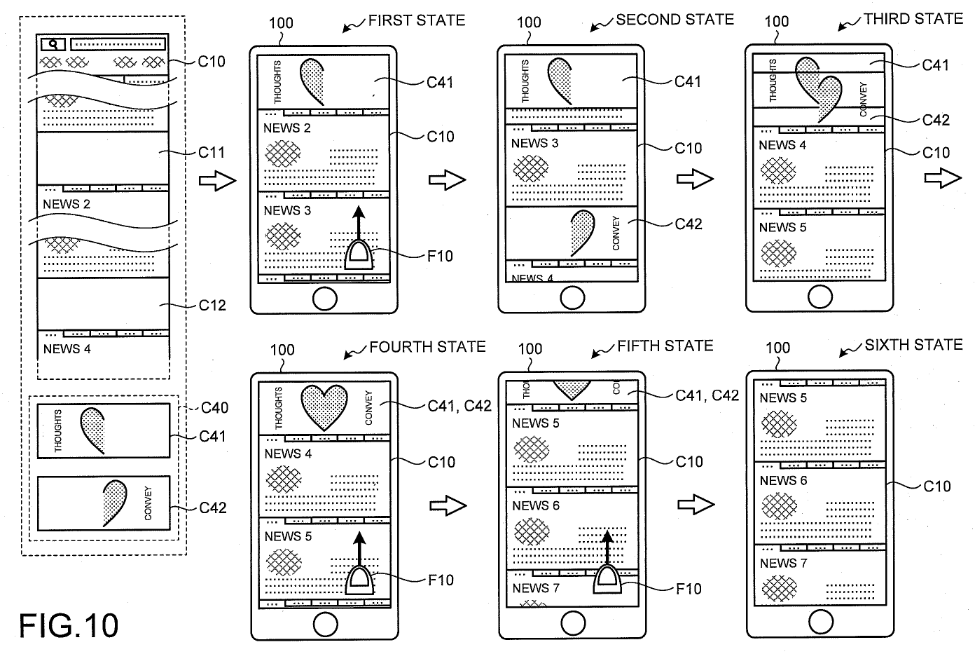

For example, FIG. 10 is a diagram illustrating an example of a process for displaying a plurality of contents by the terminal device according to the embodiment. In the example illustrated in FIG. 10, the terminal device 100 accepts distribution of the web page C10, in which the advertisement areas C11 and C12 are arranged. Furthermore, the terminal device 100 accepts, as a content C40, distribution of a content C41 and a content C42 that includes a transparent area as a part thereof. The contents C41 and C42 are contents configured such that when the content C41 is displayed behind the content C42 in an overlapping manner, the content C41 is displayed through the transparent area of the content C42 so as to provide a single content, in which a heart mark, text “convey thoughts”, and the like are arranged.

Upon accepting the distribution of the web page C10 and the content C40 as described above, the terminal device 100 performs a display process as described below. First, the terminal device 100 arranges and displays the content C41 and the web page C10 behind the content C42.

Furthermore, the terminal device 100 moves the web page C10 and the contents C41 and C42 in accordance with a scroll operation. If the upper end of the content C41 comes in contact with the upper end of the screen, the terminal device 100 fixes only the display position of the content C41.

Therefore, if the upward scroll operation is further performed, the terminal device 100 moves the display position of the content C42 in the screen upward direction, and the content C41 and the content C42 are displayed in an overlapping manner. If the display area of the content C41 and the display area the content C42 coincide with each other, the terminal device 100 fixes the display position of the content C42. Accordingly, the terminal device 100 scrolls only the web page C10 in accordance with the upward scroll operation. Thereafter, if a predetermined amount of the scroll operation is performed, the terminal device 100 releases the fixed display positions of the contents C41 and C42.

Therefore, the terminal device 100 can display the content C40 in a complicated mode such that the contents C41 and C42 overlap each other to form the single content C40, and thereafter, the content C40 is moved to the outside of the screen in accordance with the scroll operation. As a result, the terminal device 100 can improve an appeal effect of information related to the content C40.

8-2-2. Example of Display Process for Displaying Contents in Overlapping Manner

An example of a display process for displaying a plurality of the contents C41 and C42 by the terminal device 100 will be described below with reference to FIG. 10. In the following description, an example of a process for moving the web page C10 and the content C40 in the screen upward direction in accordance with an upward scroll operation and fixing the display position of the content C40 at the upper end of the screen will be described in multiple parts, from a first state to a sixth state.

First, the terminal device 100 accepts distribution of the web page C10 and the content C40. In this case, the terminal device 100 arranges the content C41 in the advertisement area C11, and arranges the content C42 in the advertisement area C12. At this time, the terminal device 100 arranges the content C41 and the web page C10 behind the content C42. Then, the terminal device 100 displays the web page C10 and the contents C41 and C42.

If an upward scroll operation is performed, the terminal device 100 scrolls the web page C10 and the contents C41 and C42 in the screen upward direction. If the upper end of the content C41 comes in contact with the upper end of the screen through the upward scroll operation, the terminal device 100 fixes the display position of the content C41 as illustrated in the first state.

If the upward scroll operation is further performed, as illustrated in the second state, the terminal device 100 scrolls the web page C10 and the content C42 while fixing the display position of the content C41. If the upward scroll operation is further performed, the terminal device 100 further scrolls the web page C10 and the content C42 in the screen upward direction while fixing the display position of the content C41, so that the content C40 is displayed such that a part of the content C41 and a part of the content C42 overlap each other as illustrated in the third state.

As illustrated in the fourth state, if the display position of the content C42 overlaps the upper end of the screen, the terminal device 100 fixes the display position of the content C42. Consequently, the terminal device 100 displays the content C40 such that the contents C41 and C42 overlap each other as if a single content is provided. Thereafter, if a predetermined amount of the upward scroll operation is performed, that is, if the upper end of the news 5 comes in contact with the lower ends of the contents C41 and C42 for example, the terminal device 100 fixes the display positions of the contents C41 and C42.

Then, as illustrated in the fifth state, the terminal device 100 gradually moves the contents C41 and C42 to the outside of the screen in accordance with the scroll operation. As illustrated in the sixth state, if the upper end of the news 5 comes in contact with the upper end of the screen, the terminal device 100 moves the entire contents C41 and C42 to the outside of the screen.

If the user performs downward scroll from the sixth state, the terminal device 100 displays the contents C41 and C42 on the screen in order of the fifth state, the fourth state, the third state, the second state, and the first state. That is, if the content C42 and the advertisement area C12 overlap each other, the terminal device 100 releases the fixed display position of the content C42 and scrolls the content C42 and the web page C10 in the screen downward direction in accordance with the downward scroll. Then, if the content C41 and the advertisement area C11 overlap each other, the terminal device 100 releases the fixed display position of the content C41 and scrolls the content C41 and the web page C10 in the screen downward direction in accordance with the downward scroll.

8-2-3. Example of Tracking Area when a Plurality of Contents are Displayed

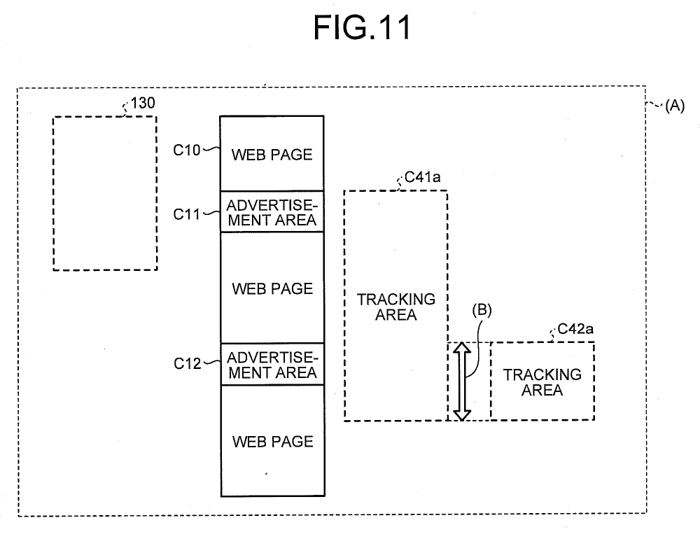

An example of setting of the tracking area for implementing the display process illustrated in FIG. 10 will be described below with reference to FIG. 11. FIG. 11 is a diagram for explaining an example of setting of the tracking area when contents are displayed in an overlapping manner. For example, in the example illustrated in (A) in FIG. 11, the advertisement areas C11 and C12 are arranged in the middle of the web page C10.

In FIG. 11, a tracking area C41a of the content C41 is set from the upper end of the advertisement area C11 in the downward direction relative to the lower end of the advertisement area C12, and a tracking area C42a of the content C42 is set from the upper end of the advertisement area C12 to the lower end of the tracking area C41a. That is, as illustrated in (A) in FIG. 11, the terminal device 100 performs setting such that parts of the tracking areas C41a and C42a overlap each other.

When the setting is performed as described above, the terminal device 100 moves an area that is displayed by the screen of the output unit 130 on the screen, in accordance with a scroll operation. Accordingly, even when the advertisement area C11 is moved to the outside of the screen, the terminal device 100 continues to display the content C41 until the tracking area C41a is moved to the outside of the screen. Furthermore, if the upper end of the advertisement area C12 comes in contact with the upper end of the screen, the terminal device 100 fixes the display position of the content C42 and continues to display the content C42 until the tracking area C42a is moved to the outside of the screen.

Consequently, the terminal device 100 displays each of the contents C41 and C42 in a complicated mode such that the contents C41 and C42 which are separately located are displayed in an overlapping manner at the upper end of the screen in accordance with the scroll operation, and thereafter, if the scroll operation is further performed, the overlapping contents C41 and C42 are moved to the outside of the screen. Therefore, the terminal device 100 can improve the appeal effect of the information related to the content C40.

8-3. Position for Fixing Content

The above-described terminal device 100 fixes each of the contents C20 to C40 at the upper end of the screen. However, the embodiment is not limited to this example. That is, the terminal device 100 may fix each of the contents C20 to C40 at an arbitrary position as long as at least a part of each of the contents C20 to C40 is displayed on the screen. For example, the terminal device 100 may fix the display position of the content C20 at a position at which the center of the content C20 overlaps the upper end of the screen.

Furthermore, the terminal device 100 may fix the contents C20 to C40 a plurality of number of times. For example, if an upward scroll operation is performed and the content C20 is moved to a first position, the terminal device 100 fixes the display position of the content C20, and thereafter, if an upward scroll operation equal to or greater than a predetermined threshold is performed, the terminal device 100 releases the fixed display position of the content C20. Moreover, the terminal device 100 may fix the display position of the content C20 again when the display position of the content C20 reaches the upper end of the screen through an upward scroll operation.

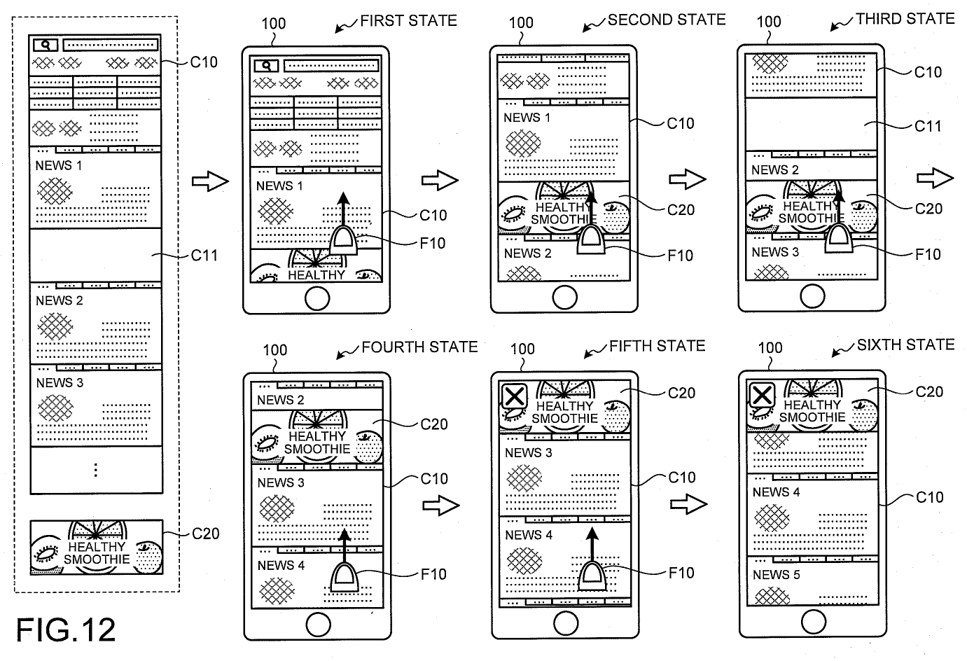

An example of a process for fixing the display position of the content C20 at a plurality of positions will be described below with reference to FIG. 12. FIG. 12 is a diagram illustrating an example of the process for fixing a content at a plurality of display positions by the terminal device according to the embodiment. In the following description, an example of a process for moving the web page C10 and the content C20 in the screen upward direction in accordance with an upward scroll operation, fixing the display position of the content C20 once in the middle of the screen, and thereafter fixing the display position of the content C20 at the upper end of the screen will be described in multiple parts, from a first state to a sixth state.

First, the terminal device 100 accepts distribution of the web page C10 and the content C20. In this case, as illustrated in the first state, the terminal device 100 arranges and displays the content C10 from the upper end of the screen, and arranges and displays the content C20 in the advertisement area C11 as an initial display. If the user performs an upward scroll operation on the web page C10 with the finger F10, the terminal device 100 scrolls the web page C10 and the content C20 in the screen upward direction in accordance with the upward scroll operation.

As illustrated in the second state, if the content C20 is scrolled to the first position, the terminal device 100 fixes the display position of the content C20. Then, if an upward scroll operation is performed, the terminal device 100 scrolls only the web page C10 without moving the content C20. For example, in the example illustrated in the third state, only the web page C10 is scrolled in the upward direction and the advertisement area C11 is moved in the screen upward direction relative to the content C20.

Furthermore, if an upward scroll operation equal to or greater than a predetermined threshold is performed after fixation of the content C20, the terminal device 100 releases the fixed display position of the content C20. For example, as illustrated in the third state, if the lower end of the content C20 and the upper end of the news 3 overlap each other, the terminal device 100 releases the fixed display position of the content C20. Then, as illustrated in the fourth state, the terminal device 100 moves the content C20 and the web page C10 in the screen upward direction in accordance with the upward scroll operation.

Moreover, as illustrated in the fifth state, if the upper end of the content C20 comes in contact with the upper end of the screen, the terminal device 100 fixes the display position of the content C20 and displays the release button. Then, as illustrated in the sixth state, even if an upward scroll operation is performed, the terminal device 100 scrolls only the web page C10 in the upward direction without moving the content C20.

As described above, the terminal device 100 scrolls the web page C10 and the content C20, and if the display position of the content C20 reaches the first position, the terminal device 100 fixes only the display position of the content C20. If the upward scroll operation equal to or greater than a predetermined threshold is further performed, the terminal device 100 releases the fixed display position of the content C20. Thereafter, if the display position of the content C20 reaches a second position through the upward scroll operation, the terminal device 100 fixes the display position of the content C20 again.

Therefore, the terminal device 100 displays the content C20 in a complicated mode such that, for example, only the web page C10 is scrolled in accordance with a scroll operation, and the display position of the content C20 is fixed at a plurality of positions independent of the scroll operation. Consequently, the terminal device 100 can make the user aware of the content C20 and improve the appeal effect of the information related to the content C20.

8-4. Scroll Operation

If an upward scroll operation is performed, the above-described terminal device 100 gradually reduces the display area of the content C20 from the screen downward direction to the screen upward direction. However, the embodiment is not limited to this example. For example, the terminal device 100 may fix the display position of the content C20 at the lower end of the screen when a downward scroll operation is performed, and may gradually reduce the display area of the content C20 from the screen upward direction to the screen downward direction when a downward scroll operation equal to or greater than a predetermined threshold is performed.

Furthermore, if a scroll operation in the horizontal direction is performed from the left side to the right side of the screen, the terminal device 100 may fix the display position of the content C20 at the right end of the screen. If the scroll operation is further performed, the terminal device 100 may gradually reduce the display area of the content C20 from the left side to the right side of the screen. That is, the terminal device 100 may gradually reduce the display area in accordance with a scroll operation in an arbitrary direction without moving the content C20.

The terminal device 100 recognizes a scroll operation performed on an area in which the web page C10 is displayed on the screen as a scroll operation on the web page C10, and scrolls the web page C10 and the content C20 arranged in the web page C10. However, the embodiment is not limited to this example. For example, the terminal device 100 may scroll the web page C10 and the content C20 in accordance with a scroll operation performed in an area in which the content C20 is displayed. That is, the terminal device 100 may move the display positions of the web page C10 and the content C20 when an operation for moving any of the web page C10 and the content C20 is performed.

The terminal device 100 may not arrange the content C20 in the advertisement area C11 of the web page C10. In this case, the terminal device 100 may separately move each of the web page C10 and the content C20 by the same distance in conjunction with each other, in accordance with a scroll operation performed on the web page C10 or the content C20.

8-5. Release of Fixed Display Position

In the above described example, the terminal device 100 releases the fixed display position when the release button is tapped or upward scroll equal to or greater than a predetermined threshold is performed. However, the embodiment is not limited to this example. For example, the terminal device 100 may release the fixed display position when a predetermined operation is performed, such as when the display position is fixed for a predetermined period (for example, three seconds), when the content is continuously touched, when the display position is displayed for a predetermined period, or when the content is tapped and a landing page corresponding to the content is displayed.

8-6. Others

The terminal device 100 may perform the display proses by appropriately combining the above-described processes. The combination may be arbitrarily set, as a display instruction, by an advertiser when an advertisement content is registered in the advertisement distribution server 20. The advertisement distribution server 20 generates control information for causing the terminal device 100 to perform the combination of the processes set by the advertiser, and distributes the generated control information to the terminal device 100. Therefore, the terminal device 100 can combine and perform the arbitrary processes described above in accordance with the setting performed by the advertiser.

9. Flow of Process Performed by the Terminal Device 100

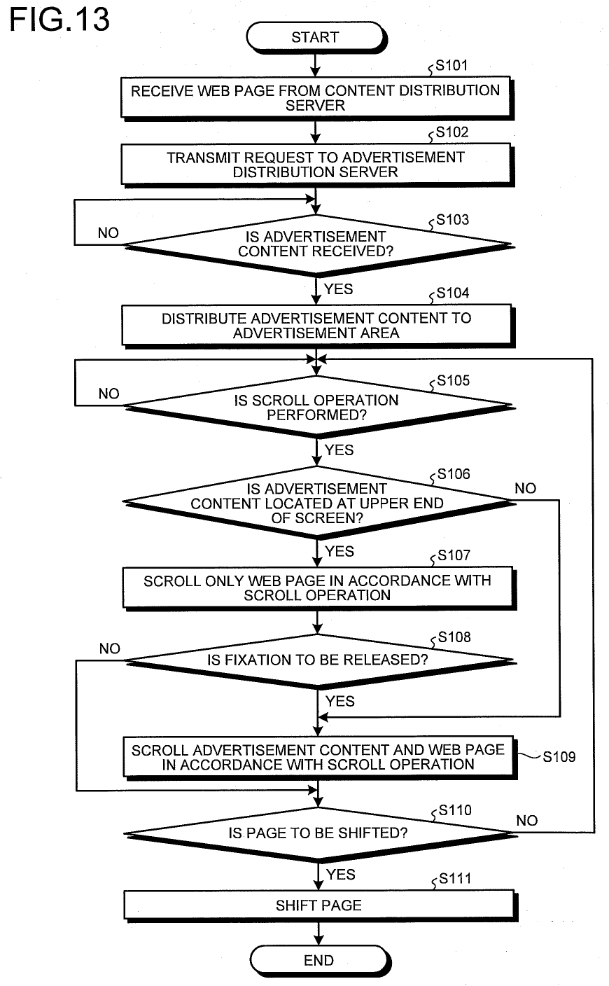

The flow of a process performed by the terminal device 100 that executes the control information will be described below with reference to FIG. 13. FIG. 13 is a flowchart illustrating an example of the flow of the display process performed by the terminal device according to the embodiment. In the example illustrated in FIG. 13, a process will be described in which a content, such as the content C20, distributed from the advertisement distribution server 20 is used as an advertisement content.

In the example illustrated in FIG. 13, the terminal device 100 requests the content distribution server 30 to distribute the web page C10 in accordance with an operation performed by a user, and receives the web page C10 from the content distribution server 30 (Step S101). Subsequently, if the distributed web page C10 includes an acquisition command, the terminal device 100 transmits a distribution request to the advertisement distribution server 20 (Step S102). Then, the terminal device 100 determines whether an advertisement content is received (Step S103). If the terminal device 100 determines that the advertisement content is not received (NO at Step S103), the process at Step S103 is repeated.

If the terminal device 100 receives the advertisement content (YES at Step S103), the terminal device 100 arranges and displays the advertisement content in the advertisement area C11 (Step S104). The terminal device 100 determines whether a scroll operation is performed (Step S105). If the scroll operation is performed (YES at Step S105), the terminal device 100 determines whether the advertisement content is located at the upper end of the screen (Step S106). If the advertisement content is located at the upper end of the screen (YES at Step S106), the terminal device 100 fixes the display position of the advertisement content, and scrolls only the web page in accordance with the scroll operation (Step S107).

The terminal device 100 determines whether to release the fixed display position of the advertisement content (Step S108). For example, the terminal device 100 determines whether a predetermined operation, such as tapping of the release button or a predetermined amount of a scroll operation, for releasing the fixed display position of the advertisement content has been performed. If the terminal device 100 determines to release the fixed display position of the advertisement content (YES at Step S108), the terminal device 100 releases the fixed display position of the advertisement content, and scrolls the advertisement content and the web page C10 in accordance with the scroll operation (Step S109).

The terminal device 100 determines whether to shift the web page through a process of tapping a link or the like performed by the user (Step S110). If the terminal device 100 determines to shift the web page (YES at Step S110), the terminal device 100 shifts the web page (Step S111), and the process ends.

In contrast, if the terminal device 100 determines not to shift the web page (NO at Step S110), the terminal device 100 performs the process at Step S105. If the scroll operation is not performed (NO at Step S105), the terminal device 100 repeats the process at Step S107. If the advertisement content is not located at the upper end of the screen (NO at Step S106), the terminal device 100 does not fix the display position of the advertisement content, and scrolls the advertisement content and the web page C10 in accordance with the scroll operation. If the terminal device 100 determines not to release the fixed advertisement content (NO at Step S108), the terminal device 100 performs the process at Step S110.

10. Modifications

An example of the display process performed by the terminal device 100 has been described above by using the display modes illustrated in FIG. 1, FIG. 8, FIG. 10, and FIG. 12. However, the embodiment is not limited to this example. Variations of the display process performed by the terminal device 100 will be described below. It is assumed that the display process described below is implemented by, for example, a process performed by the display unit 154, the moving unit 155, and the fixing unit 156.

10-1. Mode of Content

The above-described terminal device 100 displays a plurality of the contents C31 and C32 included in the content C30. However, the embodiment is not limited to this example. For example, the contents C31 and C32 may be contents related to different advertisements. Furthermore, the terminal device 100 may display the content C30 configured to provide different contents between when the contents C31 and C32 are separately displayed and when the contents C31 and C32 are arranged next to each other. The same applies to the contents C41 and C42 included in the content C40.

10-2. Content

In the above description, an example has been described in which the terminal device 100 displays the contents C20 to C40 related to advertisement. However, the embodiment is not limited to this example. For example, the terminal device 100 may display a content including a character string, a pattern, an image, a moving image, or the like. Furthermore, the terminal device 100 may display the contents C20 to C40 including a game or the like, instead of a content related to advertisement, or may display the contents C20 to C40 including a so-called playable advertisement. Moreover, the terminal device 100 may display the contents C20 to C40 including audio. The character string, the pattern, the image, the moving image, the game, the audio, and the like included in the contents C20 to C40 are not limited to those related to advertisement.

Furthermore, the content C20 is not limited to the content related to advertisement. For example, when displaying a game content instead of the web page C10, the terminal device 100 may display, as the contents C20 to C40, an auxiliary content, such as a game menu or a game tutorial. Moreover, when displaying an interactive web page generated by a technology using flash, CSS, or the like at the time of execution of the game, the terminal device 100 may display the contents C20 to C40 and perform the display process.

Furthermore, the terminal device 100 may display the contents C20 to C40 together with a content of a social networking service (SNS), a screen of a messenger application, a screen of a camera application, or any other content, and thereafter, may perform the display process as described above. Moreover, the terminal device 100 may display an arbitrary content, such as a game, a map, a music playback screen, or a video playback screen, in addition to the web page C10.

10-3. Control Information

The above-described terminal device 100 performs the above-described display process by using the control information that is distributed from the advertisement distribution server 20 together with the content C20. However, the embodiment is not limited to this example. For example, the terminal device 100 receives the above-described control information from the content distribution server 30 together with the web page, and receives a control instruction from the advertisement distribution server 20 together with the content C20. Then, the terminal device 100 may execute the control information received from the content distribution server 30, and perform the display process in accordance with the received control instruction.

Furthermore, the terminal device 100 may download, in advance, an application for causing the terminal device 100 to perform a process of displaying the web page C10, the above-described display process, and the like, and may implement the above-described processes by executing the application.

10-4. Configuration of Apparatus

In the above-described embodiment, an example has been described in which the distribution system 1 includes the advertisement distribution server 20 and the content distribution server 30. However, the advertisement distribution server 20 and the content distribution server 30 may be configured as a single device. In this case, the advertisement distribution server 20 illustrated in FIG. 3 includes, for example, the content storage unit 32, the accepting unit 34, and the distribution unit 35 illustrated in FIG. 5. The advertisement distribution server 20, upon accepting an acquisition request for a web page from the terminal device 100, distributes an advertisement content and a web page that does not include an acquisition command to the terminal device 100.

In the above-described embodiment, an example has been described in which the advertisement distribution server 20 distributes the content C20 to the terminal device 100. However, the content distribution server 30 may acquire the content C20 from the advertisement distribution server 20. In this case, the request accepting unit 26 of the advertisement distribution server 20 accepts an acquisition request for the content C20 from the content distribution server 30. The advertisement distribution server 20 distributes the content C20 to the content distribution server 30. The content distribution server 30 distributes the content C20 acquired from the advertisement distribution server 20 and a web page that does not include an acquisition command to the terminal device 100.

10-5. Log

The terminal device 100 may acquire a log indicating whether the contents C20 to C40 are displayed, or a log of a content selected by a user. Furthermore, the terminal device 100 may measure, for each image, a time at which the user performs a selection, in addition to the number of displays or the number of selections of the contents C20 to C40. Moreover, the terminal device 100 may acquire a log indicating whether the contents C20 to C40 are displayed from the initial screen, whether the display positions of the contents C20 to C40 are fixed, and positions at which the display positions of the contents C20 to C40 are fixed. Furthermore, the terminal device 100 may acquire a log indicating whether the content C31 and the content C32 are displayed in a contact state and whether the content C41 and the content C42 are displayed in an overlapping state.

Moreover, the terminal device 100 may acquire a log indicating whether the display positions of the contents C20 to C40 are fixed and thereafter the fixed display positions are released, whether the release button C21 is displayed, and whether the release button C21 is tapped. Furthermore, when the user selects the contents C20 to C40 and displays a landing page, the terminal device 100 may acquire; for each of the contents, a log indicating the display position of each of the contents C20 to C40, whether the display position is fixed, and whether the fixed display position is released.

For example, if a user ends the display of the web page C10 without performing a scroll operation, the terminal device 100 may acquire a log indicating that the display position of the content C20 is not fixed. In contrast, if the user performs an upward scroll operation from the initial screen and fixes the display position of the content C20, the terminal device 100 may acquire a log indicating that the content C20 is displayed.

The log acquired by the terminal device 100 as described above is useful when the number of impressions or the CTR of the contents C20 to C40 is updated, when a charging process for display of the contents C20 to C40 is performed, and when an advertising effect is reported to the advertiser. For example, when the release button C21 is tapped to release the fixed display position of the content C20 and then the content C20 is not displayed again, it is expected that the user is not interested in the content C20. Furthermore, when the upward scroll operation and the downward scroll operation are performed a number of times, when the display positions of the contents C20 to C40 are fixed a number of times through the scroll operations, or when the fixed display positions are released a number of times, it is expected that the user is interested in the contents C20 to C40 and has changed the display mode a number of times.

Therefore, a log indicating a change in the display modes of the contents C20 to C40, a log indicating a scroll operation from the initial screen, a log indicating whether the release button C21 is tapped, a log indicating the number of times the contents C31 and C32 are displayed in a contact state, and a log indicating whether the contents C41 and C42 are displayed in an overlapping manner can be an index of whether the user is interested in the contents C20 to C40. Furthermore, the number of times each of the contents C20 to C40 is displayed or operated by a single access can be an index of user's awareness of the advertisement.

Therefore, the advertisement distribution server 20 may update the number of impressions or may change the amount of fees by using each of the acquired logs. For example, the advertisement distribution server 20 may change the amount of fees depending on whether an upward scroll operation is performed from an initial image and the display positions of the contents C20 to C40 are fixed, whether the fixed display positions are released, whether the content C31 and the content C32 come in contact with each other, or whether the content C41 and the content C42 overlap each other, or depending on the number of occurrences of the above-described states or the like.

Furthermore, the log acquired by the terminal device 100 may be used to change a content arranged in the landing page. For example, when the user selects the content C20, the terminal device 100 may provide a different landing page depending on whether the display position of the content C20 is fixed, whether the fixed display position is released, or whether the release button C21 is tapped, or depending on the size of the display area of the content C20. Moreover, the terminal device 100 may acquire the same landing page, provide contents of an acquired log or the like to a server that distributes the landing page, and cause the server to change contents arranged in the landing page.

10-6. Operation record of terminal device

The above-described terminal device 100 may transmit, to the advertisement distribution server 20, a record indicating the degree of operations that a user has performed on the terminal device 100 with respect to a web page in which the contents C20 to C40 according to the embodiment are arranged. Specifically, the terminal device 100 records the contents of scroll operations performed when the contents C20 to C40 are arranged, the number of times of the scroll operations, a selection operation performed by the user, positions at which the user selects the contents C20 to C40, display modes of the selected contents C20 to C40, fixation of the display positions of the contents C20 to C40, release of the fixed display positions, and the like.

Furthermore, the terminal device 100 may record various operations such as the number of selections of the contents C20 to C40, the number of times of reload, an operation of transmitting information for identifying the contents C20 to C40 from the terminal device 100 (for example, writing in an SNS or the like), which is performed by the user on the terminal device 100. The terminal device 100 transmits information on the operation history to the advertisement distribution server 20.

In this case, the advertisement distribution server 20 aggregates information on the operation history distributed from the terminal device 100, and further acquires information obtained by analyzing the aggregated information. For example, the advertisement distribution server 20 acquires the number of times of the scroll operations, the number of executions of the display process, a type of the displayed landing page, a type of a content arranged in the landing page, information on comparison of indices, such as CTRs, of the advertising effect, for both of the case where the contents C20 to C40 are distributed together with the control information and the case where the contents C20 to C40 are not distributed together with the control information.

The history of operations performed on the web page C10 when the contents C20 to C40 are distributed together with the control information may be used as an index of the advertising effect. That is, in the web page in which the contents C20 to C40 including the control information according to the embodiment are displayed, not only the fact that a user clicks the contents C20 to C40 and a web page (landing page) linked from the contents C20 to C40 is displayed, but also the operation history itself indicating the number of operations performed by the user on the web page C10 (that is, the number of times that the user changes the display mode of the screen) may be used as an index of the user's interest in the contents C20 to C40.

For example, when a user performs an upward scroll operation from the initial screen, the advertisement distribution server 20 compares the number of times the user fixes the display positions of the contents C20 to C40, the number of times of tapping of the release button C21, the number of displays of the contents C20 to C40, and a time during which the contents C20 to C40 are displayed, so that it is possible to provide an index indicating the degree of interest in information expected to be broadly conveyed by the contents C20 to C40 when the contents C20 to C40 with the control information according to the embodiment are displayed, that is, it is possible to provide an index indicating the degree of interest in the advertisement.

Therefore, by transmitting the information on the operation history of the terminal device 100 to the advertiser terminal 10, the advertisement distribution server 20 can provide a report indicating the index of the advertising effect of the web page C10 in which the contents C20 to C40 according to the embodiment are displayed. The advertisement distribution server 20 may directly transmit the information or the log on the operation history of the terminal device 100 to the advertiser terminal 10.

Consequently, the advertisement distribution server 20 can provide an advertiser with indication of how the display modes of the contents C20 to C40 with the control information according to the embodiment are useful in the terminal device 100.

10-7. Others

Of the processes described in the embodiment, all or part of a process described as being performed automatically may also be performed manually. Alternatively, all or part of a process described as being performed manually may also be performed automatically by known methods. In addition, the processing procedures, specific names, and information including various kinds of data and parameters illustrated in the above-described document and drawings may be arbitrarily changed unless otherwise specified. For example, various kinds of information illustrated in the drawings are not limited to the information illustrated in the drawings.

The components of the apparatuses illustrated in the drawings are functionally conceptual and need not necessarily be physically configured in the manner illustrated in the drawings. In other words, specific forms of distribution and integration of the apparatuses are not limited to those illustrated in the drawings, and all or part of the apparatuses may be functionally or physically distributed or integrated in arbitrary units depending on various loads or use conditions. For example, the requesting unit 151 and the operation control unit 152 illustrated in FIG. 6 may be integrated with each other.

Furthermore, the embodiments may be combined appropriately as long as the processes do not conflict with each other.

10-8. Program

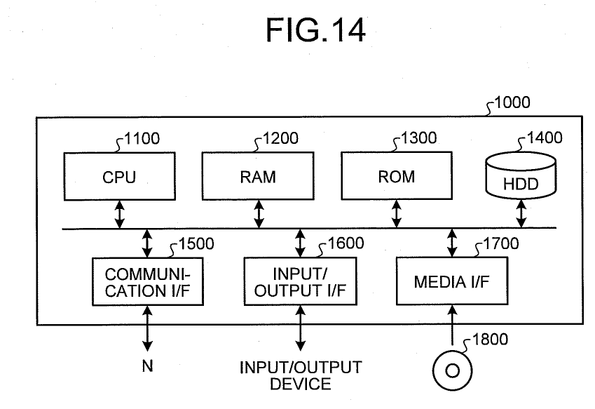

The terminal device 100, the advertisement distribution server 20, and the content distribution server 30 according to the above-described embodiment are implemented by, for example, a computer 1000 with a configuration as illustrated in FIG. 14. In the following, a description will be given by using the advertisement distribution server 20 as an example. FIG. 14 is a diagram illustrating an example of a hardware configuration of a computer that implements the functions of the advertisement distribution server. The computer 1000 includes a CPU 1100, a RAM 1200, a ROM 1300, an HDD 1400, a communication interface (I/F) 1500, an input/output I/F 1600, and a media I/F 1700.

The CPU 1100 operates based on a program stored in the ROM 1300 or the HDD 1400, and controls each of units. The ROM 1300 stores therein a boot program executed by the CPU 1100 when the computer 1000 is activated, a program that depends on the hardware of the computer 1000, and the like.

The HDD 1400 stores therein a program executed by the CPU 1100, data used by the program, and the like. The communication I/F 1500 receives data from other devices via the network N, sends the data to the CPU 1100, and transmits data generated by the CPU 1100 to other devices.

The CPU 1100 controls an output device, such as a display or a printer, an input device, such as a keyboard or a mouse, and the like via the input/output I/F 1600. The CPU 1100 acquires data from the input device via the input/output I/F 1600. The CPU 1100 outputs generated data to the output device via the input/output I/F 1600.

The media I/F 1700 reads a program or data stored in a recording medium 1800, and provides the program or the data to the CPU 1100 via the RAM 1200. The CPU 1100 loads the program onto the RAM 1200 from the recording medium 1800 via the media I/F 1700, and executes the loaded program. The recording medium 1800 may be, for example, an optical recording medium such as a digital versatile disk (DVD) or a phase change rewritable disk (PD), a magneto-optical recording medium such as a magneto-optical disk (MO), a tape medium, a magnetic recording medium, a semiconductor memory, or the like.

For example, when the computer 1000 functions as the advertisement distribution server 20 according to the embodiment, the CPU 1100 of the computer 1000 implements the functions of the control unit 23 by executing the program loaded on the RAM 1200. Furthermore, the HDD 1400 stores therein data stored in the storage unit 22, that is, the advertisement database 24. While the CPU 1100 of the computer 1000 reads the program from the recording medium 1800 and executes the program, the program may be acquired from other devices as another example.

When the computer 1000 functions as the terminal device 100 according to the embodiment, the CPU 1100 of the computer 1000 implements the functions of the control unit 150 by executing the program loaded on the RAM 1200.

When the computer 1000 functions as the content distribution server 30 according to the embodiment, the CPU 1100 of the computer 1000 implements the functions of the control unit 33 by executing the program loaded on the RAM 1200. The HDD 1400 stores therein data in the content storage unit 32.

11. Advantageous Effects

As described above, the terminal device 100 displays the web page C10 and the content C20, moves the web page C10 and the content C20 in accordance with a scroll operation performed on the web page C10 or the content C20, and fixes the display position of the content C20 when the content C20 is moved to a predetermined position.

Therefore, if a user performs an upward scroll operation, the terminal device 100 fixes the content C20 on the screen and does not move the content C20 even when the scroll operation is performed. Consequently, it is possible to make the user aware of the content C20 and improve the appeal effect of the information related to the content C20. Furthermore, the terminal device 100 can ensure the first view of the content C20.

More specifically, when the terminal device 100 displays the content C20 related to advertisement, it is possible to attract interest of the user in the content C20 related to advertisement. Therefore, it is possible to improve the appeal effect of the information expected to be conveyed by the content C20, that is, an advertisement content, and improve the advertising effect.

Furthermore, if the display position of the content C20 is fixed, the terminal device 100 moves only the web page C10 in accordance with a scroll operation. Therefore, the terminal device 100 can attract interest in the content C20, and attract attention of the user to the content C20.

Moreover, if the display position of the content C20 is fixed, the terminal device 100 displays the release button C21 such that the release button C21 overlaps the content C20. Therefore, the terminal device 100 can release the fixed display position of the content C20 for a user who is not interested in the content C20, so that it is possible to prevent the user from getting a negative impression of the content C20.

Furthermore, if the user selects the release button C21, the terminal device 100 arranges and displays the content C20 in the advertisement area C11 included in the web page C10. Therefore, if the user is not interested in the content C20, the terminal device 100 displays the content C20 in a normal mode in which the content C20 is arranged and displayed in the advertisement area C11. Consequently, it is possible to prevent the user from getting a negative impression of the content C20.

Moreover, if the user selects the release button C21, the terminal device 100 moves the web page C10 and the content C20 in accordance with a moving operation. Therefore, when the user is not interested in the content C20, the terminal device 100 can display the content C20 in the normal mode.

Furthermore, if a predetermined operation is performed after fixation of the display position of the content C20, the terminal device 100 releases the fixed display position of the content C20. For example, if a scroll operation equal to or greater than a predetermined threshold is performed or if a predetermined period has elapsed after fixation of the display position of the content C20, the terminal device 100 releases the fixed display position of the content C20. Therefore, the terminal device 100 can return the display mode of the content C20 to the normal mode when it is determined that the first view of the content C20 is ensured. Consequently, it is possible to prevent the user from getting a negative impression of the content C20.

Moreover, if the display position of the content C20 is fixed at a first position on the screen and thereafter a moving operation equal to or greater than a predetermined threshold is performed, the terminal device 100 releases the fixed display position and fixes the display position of the content C20 again at a second position on the screen. Therefore, the terminal device 100 displays the content C20 in a complicated mode such that the display position-of the content C20 is fixed at a plurality of positions. Consequently, it is possible to attract attention of the user to the content C20 and attract interest in the content C20.

Furthermore, if the content C20 is moved to an end of the screen in a direction in which the scroll operation is performed, the terminal device 100 fixes the display position of the content C20. For example, if the upper end of the content C20 comes in contact with the upper end of the screen, the terminal device 100 fixes the display position of the content C20. Therefore, the terminal device 100 fixes the display position of the content C20 at the end of the screen in the scroll direction, so that it is possible to make the user aware of the content C20 and cause the user to view the content C20. Consequently, it is possible to improve the appeal effect of the information related to the content C20.

Moreover, the terminal device 100 displays the web page C10 and the contents C31 and C32, and moves the web page C10 and the contents C31 and C32 in accordance with a moving operation. The terminal device 100 fixes the display position of the content C31 when the upper end of the content C31 comes in contact with the upper end of the screen, and releases the fixed display position of the content C31 when the upper end of the content C32 comes in contact with the lower end of the content C31. Therefore, for example, the terminal device 100 can display the content C30 in a complicated mode such that the content C31 is not moved even when a scroll operation is performed, and the content C31 is pushed to the outside of the screen by the content C32 when the content C31 and the content C32 come in contact with each other. Consequently, the terminal device 100 can attract interest of the user in the content C30 and improve the appeal effect of the information related to the content C30.

Furthermore, if the upper end of the content C32 comes in contact with the upper end of the screen, the terminal device 100 fixes the display position of the content C32. Therefore, the terminal device 100 can attract interest of the user in not only the content C31 but also the content C32.

Moreover, the terminal device 100 displays, as the content C31 and the content C32, images obtained by dividing a predetermined image. Therefore, for example, the terminal device 100 can display the content C30 in a complicated mode such that the content C32 approaches the content C31 located at the fixed display position in accordance with an upward scroll operation, the content C31 and the content C32 are displayed as a non-divided single image, and thereafter the content C31 is pushed to the outside of the screen by the content C32. Therefore, the terminal device 100 can attract interest of the user in the content C30 and improve the appeal effect of the information related to the content C30.

Furthermore, the terminal device 100 arranges and displays the web page C10 and the content C41 behind the content C42 including a transparent area as a part thereof, and moves the web page C10, the content C41, and the content C42 in accordance with a scroll operation. If the upper end of the content C41 comes in contact with the upper end of the screen, the terminal device 100 fixes only the display position of the content C41. Therefore, the terminal device 100 can display the content C40 in a complicated mode such that the contents C41 and C42 overlap each other to provide the single content C40, and thereafter the content C40 is moved to the outside of the screen in accordance with the scroll operation. Consequently, the terminal device 100 can improve the appeal effect of the information related to the content C40.

Moreover, the terminal device 100 displays the content C41 and the content C42 that provide a single content when displayed in an overlapping manner. Therefore, the terminal device 100 can attract interest of the user in the content C40 and further improve the appeal effect of the information related to the content C40.

Furthermore, if the fixed content C20 is released, the terminal device 100 reduces the display area of the content C20 in a direction in which a scroll operation is performed, without moving the content C20 in accordance with the scroll operation. Therefore, the terminal device 100 can make the user aware of the content C20 and improve the appeal effect of the information related to the content C20.

While the embodiments of the present invention have been described above in detail, these embodiments are mere examples, and the present invention may be embodied in various different forms including modifications based on the knowledge of those skilled in the art, other than the above-described embodiments.

Furthermore, “a unit” recited in the claims may be replaced with “a section, a module, or a means” or “a circuit”. For example, the distribution unit may be replaced with a distribution means or a distribution circuit.

According to an embodiment of the present invention, it is possible to improve an appeal effect of information related to a content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information display apparatus comprising:
a display unit that displays a first content and a second content different from the first content;
a moving unit that moves the first content and the second content in accordance with a moving operation of moving one of the first content and the second content; and
a fixing unit that fixes a display position of the second content when the second content is moved to a predetermined position on a screen in accordance with the moving operation.

2. The information display apparatus according to claim 1, wherein when the fixing unit fixes the display position of the second content, the moving unit moves only the first content in accordance with the moving operation.

3. The information display apparatus according to claim 1, wherein when the fixing unit fixes the display position of the second content, the display unit displays a release display for releasing the fixed display position when being selected by a user, the release display being arranged so as to overlap the second content.

4. The information display apparatus according to claim 3, wherein when a user selects the release display, the display unit arranges and displays the second content in a predetermined area included in the first content.

5. The information display apparatus according to claim 3, wherein when the user selects the release display, the moving unit moves the first content and the second content in accordance with the moving operation.

6. The information display apparatus according to claim 1, wherein when a predetermined operation is performed after fixation of the display position of the second content, the fixing unit releases the fixed display position of the second content.

7. The information display apparatus according to claim 6, wherein when the moving operation equal to or greater than a predetermined threshold is performed after fixation of the display position of the second content, the fixing unit releases the fixed display position of the second content.

8. The information display apparatus according to claim 6, wherein when a predetermined period has elapsed after fixation of the display position of the second content, the fixing unit releases the fixed display position of the second content.

9. The information display apparatus according to claim 1, wherein when the display position of the second content is fixed at a first position on the screen and thereafter the moving operation equal to or greater than a predetermined threshold is performed, the fixing unit releases the fixed display position and then fixes the display position of the second content at a second position on the screen.

10. The information display apparatus according to claim 1, wherein when the second content is moved to an end of the screen in a direction in which the moving operation is performed, the fixing unit fixes the display position of the second content.

11. The information display apparatus according to claim 1, wherein
the display unit displays the first content, the second content, and a third content different from the first content,
the moving unit moves the first content, the second content, and the third content in accordance with the moving operation,
the fixing unit fixes the display position of the second content when an upper end of the second content comes in contact with an upper end of the screen, and
the fixing unit releases the fixed display position of the second content when an upper end of the third content comes in contact with a lower end of the second content.

12. The information display apparatus according to claim 11, wherein when the upper end of the third content comes in contact with the upper end of the screen, the fixing unit fixes a display position of the third content.

13. The information display apparatus according to claim 11, wherein the display unit displays, as the second content and the third content, images obtained by dividing a predetermined image.

14. The information display apparatus according to claim 1, wherein
the display unit displays the first content and the second content behind the third content that includes a transparent area as a part thereof,
the moving unit moves the first content, the second content, and the third content in accordance with the moving operation, and
the fixing unit fixes only the display position of the second content when an upper end of the second content comes in contact with an upper end of the screen.

15. The information display apparatus according to claim 14, wherein the display unit displays the second content and the third content that provide a single content when displayed in an overlapping manner.

16. The information display apparatus according to claim 6, wherein when fixation of the second content is released, the display unit reduces a display area of the second content in a direction in which the moving operation is performed, in accordance with the moving operation without moving the second content.

17. A distribution apparatus comprising:
a distribution unit that distributes control information to a terminal device that displays a first content and a second content different from the first content, wherein
the control information causes the terminal device to display the first content and the second content,
move the first content and the second content in accordance with a moving operation of moving one of the first content and the second content, and
fix a display position of the second content when the second content is moved to a predetermined position on a screen in accordance with the moving operation.

18. An information display method comprising:
displaying a first content and a second content different from the first content;
moving the first content and the second content in accordance with a moving operation of moving one of the first content and the second content; and
fixing a display position of the second content when the second content is moved to a predetermined position on a screen in accordance with the moving operation.

19. A non-transitory computer readable storage medium having stored therein an information display program causing a computer to execute a process comprising:
displaying a first content and a second content different from the first content;
moving the first content and the second content in accordance with a moving operation of moving one of the first content and the second content; and
fixing a display position of the second content when the second content is moved to a predetermined position on a screen in accordance with the moving operation.
